(19) United States
(12) Patent Application Publication
(10) Pub. No.: US 2026/0255315 A1
(43) Pub. Date: Aug. 27, 2026

(54) SIGNALING ASPECTS OF DISTANCE ESTIMATION FOR LINE OF SIGHT MULTIPLE INPUT MULTIPLE OUTPUT COMMUNICATIONS

(71) Applicant: QUALCOMM Incorporated, San Diego, CA (US)

(72) Inventors: Pinar SEN, San Diego, CA (US); Abdelrahman Mohamed Ahmed Mohamed IBRAHIM, San Diego, CA (US); Seyong PARK, San Diego, CA (US); Renqiu WANG, San Diego, CA (US); Muhammad Sayed Khairy ABDELGHAFFAR, San Jose, CA (US); Yu ZHANG, San Diego, CA (US); Krishna Kiran MUKKAVILLI, San Diego, CA (US); Tingfang JI, San Diego, CA (US)

(21) Appl. No.: 18/714,433

(22) PCT Filed: Jan. 26, 2022
(86) PCT No.: PCT/CN2022/073945

§ 371 Date: May 29, 2024

(51) Int. Cl. H04W 64/00; H04B 17/318

(52) U.S. Cl. CPC H04W 64/006; H04B 17/318

(57) ABSTRACT

Methods, systems, and devices for signaling aspects of distance estimation for line of sight (LOS) multiple input multiple output (MIMO) communications are described. In some examples, a wireless device may receive an indication of resources of a configuration for the wireless device to use to determine a distance between a first antenna array of the wireless device and a second antenna array of a network node. In some examples, the wireless device may receive signals according to the indicated resources of the configuration. In such examples, the wireless device may transmit, to the network node, an indication of the distance that is based at least in part on the signals received according to the configuration. In some examples, the wireless device may transmit signals according to the indicated resources of the configuration. In such examples, the wireless device may receive, from the network node, an indication of the distance.

### CROSS REFERENCE

The present application is a 371 national phase filing of International PCT Application No. PCT/CN2022/073945 by SEN et al., entitled “SIGNALING ASPECTS OF DISTANCE ESTIMATION FOR LINE OF SIGHT MULTIPLE INPUT MULTIPLE OUTPUT COMMUNICATIONS,” filed Jan. 26, 2024, which is assigned to the assignee hereof, and which is expressly incorporated by reference in its entirety herein.

### FIELD OF TECHNOLOGY

The following relates to wireless communications, including signaling aspects of distance estimation for line of sight (LOS) multiple input multiple output (MIMO) communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some examples, the structure of a line of sight (LOS) channel may be exploited to achieve high multiplexing gain. In some examples, LOS transmission techniques may be deficient.

### SUMMARY

The described techniques relate to improved methods, systems, devices, and apparatuses that support signaling aspects of distance estimation for line of sight (LOS) multiple input multiple output (MIMO) communications. In some examples, a user equipment (UE) may be configured to estimate the distance between a receiving and a transmitting antenna and may report the distance estimate back to a base station. In other examples, the base station may be configured to estimate the distance between a receiving and a transmitting antenna and may report the distance estimate back to the UE.

A method is described. The method may include receiving an indication of resources of a configuration for the wireless device to use to determine a distance between a first antenna array of the wireless device that includes a first set of multiple antenna elements and a second antenna array of a network node that includes a second set of multiple antenna elements, receiving signals according to the indicated resources of the configuration, and transmitting, to the network node, an indication of the distance that is based on the signals received according to the configuration.

An apparatus is described. The apparatus may include a processor, memory coupled with the processor, and instructions stored in the memory. The instructions may be executable by the processor to cause the apparatus to receive an indication of resources of a configuration for the wireless device to use to determine a distance between a first antenna array of the wireless device that includes a first set of multiple antenna elements and a second antenna array of a network node that includes a second set of multiple antenna elements, receive signals according to the indicated resources of the configuration, and transmit, to the network node, an indication of the distance that is based on the signals received according to the configuration.

Another apparatus is described. The apparatus may include means for receiving an indication of resources of a configuration for the wireless device to use to determine a distance between a first antenna array of the wireless device that includes a first set of multiple antenna elements and a second antenna array of a network node that includes a second set of multiple antenna elements, means for receiving signals according to the indicated resources of the configuration, and means for transmitting, to the network node, an indication of the distance that is based on the signals received according to the configuration.

A non-transitory computer-readable medium storing code is described. The code may include instructions executable by a processor to receive an indication of resources of a configuration for the wireless device to use to determine a distance between a first antenna array of the wireless device that includes a first set of multiple antenna elements and a second antenna array of a network node that includes a second set of multiple antenna elements, receive signals according to the indicated resources of the configuration, and transmit, to the network node, an indication of the distance that is based on the signals received according to the configuration.

In some examples of the method, apparatuses, and non-transitory computer-readable medium described herein, transmitting the indication of the distance may include operations, features, means, or instructions for transmitting, to the network node, an indication of a signal strength value for the received signals that may be determined by the wireless device.

In some examples of the method, apparatuses, and non-transitory computer-readable medium described herein, transmitting the indication of the distance may include operations, features, means, or instructions for transmitting, to the network node, an indication of a distance value that may be determined by the wireless device based at least in part a signal strength for the received signals.

In some examples of the method, apparatuses, and non-transitory computer-readable medium described herein, receiving the signals according to the indicated resources may include operations, features, means, or instructions for receiving channel state information (CSI) reference signals (RSs), the indication of the distance determined by the wireless device based on the received CSI-RSs.

In some examples of the method, apparatuses, and non-transitory computer-readable medium described herein, receiving the signals according to the indicated resources may include operations, features, means, or instructions for receiving second reference signals for determining the distance that may be different from a CSI-RS, the indication of the distance determined by the wireless device based on the received second reference signals.

In some examples of the method, apparatuses, and non-transitory computer-readable medium described herein, the received signals include positioning signals received from one or more satellites of a global navigation system, and transmitting the indication of the distance may include operations, features, means, or instructions for transmitting positioning information for the wireless device that may be based on the received positioning signals.

In some examples of the method, apparatuses, and non-transitory computer-readable medium described herein, the received signals include positioning reference signals (PRSs) received from one or more base stations, and transmitting the indication of the distance may include operations, features, means, or instructions for transmitting positioning information for the wireless device that may be based on the received PRSs.

In some examples of the method, apparatuses, and non-transitory computer-readable medium described herein, receiving the indication of the resources of the configuration may include operations, features, means, or instructions for receiving an indication of a period, where the indication of the distance may be transmitted according to the period.

In some examples of the method, apparatuses, and non-transitory computer-readable medium described herein, receiving the indication of the resources of the configuration may include operations, features, means, or instructions for receiving an indication of at least one of a timer value or a threshold value for a difference between distances between the first antenna array and the second antenna array, where the wireless device may be to transmit the indication of the distance to the network node according to the indication of the at least one of the timer value or the threshold value.

Some examples of the method, apparatuses, and non-transitory computer-readable medium described herein may further include operations, features, means, or instructions for receiving a set of index values and a set of distance values, each index value of the set of index values corresponding to one of the set of distance values and selecting, from the set of index values based on the signals received according to the configuration, an index value corresponding to the distance, where the selected index value may be the indication of the distance.

In some examples of the method, apparatuses, and non-transitory computer-readable medium described herein, the selected index value may be transmitted as at least a portion of a CSI report, an uplink LOS media access control (MAC) control element (CE), a second MAC CE different from the uplink LOS MAC CE, a measurement report, or any combination thereof.

In some examples of the method, apparatuses, and non-transitory computer-readable medium described herein, the wireless device includes a user equipment (UE) or a relay node.

A method for wireless communication at a wireless device is described. The method may include receiving, from a network node, an indication of resources of a configuration for the wireless device to use to transmit signals to the network node, the signals associated with the network node determining a distance between a first antenna array of the wireless device that includes a first set of multiple antenna elements and a second antenna array of the network node that includes a second set of multiple antenna elements, transmitting signals according to the indicated resources of the configuration, and receiving, from the network node, an indication of the distance that is based on the signals transmitted according to the configuration.

An apparatus for wireless communication at a wireless device is described. The apparatus may include a processor, memory coupled with the processor, and instructions stored in the memory. The instructions may be executable by the processor to cause the apparatus to receive, from a network node, an indication of resources of a configuration for the wireless device to use to transmit signals to the network node, the signals associated with the network node determining a distance between a first antenna array of the wireless device that includes a first set of multiple antenna elements and a second antenna array of the network node that includes a second set of multiple antenna elements, transmit signals according to the indicated resources of the configuration, and receive, from the network node, an indication of the distance that is based on the signals transmitted according to the configuration.

Another apparatus for wireless communication at a wireless device is described. The apparatus may include means for receiving, from a network node, an indication of resources of a configuration for the wireless device to use to transmit signals to the network node, the signals associated with the network node determining a distance between a first antenna array of the wireless device that includes a first set of multiple antenna elements and a second antenna array of the network node that includes a second set of multiple antenna elements, means for transmitting signals according to the indicated resources of the configuration, and means for receiving, from the network node, an indication of the distance that is based on the signals transmitted according to the configuration.

A non-transitory computer-readable medium storing code for wireless communication at a wireless device is described. The code may include instructions executable by a processor to receive, from a network node, an indication of resources of a configuration for the wireless device to use to transmit signals to the network node, the signals associated with the network node determining a distance between a first antenna array of the wireless device that includes a first set of multiple antenna elements and a second antenna array of the network node that includes a second set of multiple antenna elements, transmit signals according to the indicated resources of the configuration, and receive, from the network node, an indication of the distance that is based on the signals transmitted according to the configuration.

In some examples of the method, apparatuses, and non-transitory computer-readable medium described herein, transmitting the signals according to the indicated resources of the configuration may include operations, features, means, or instructions for transmitting a power headroom report that includes an indication of a pathloss associated with communications between the wireless device and the network node.

In some examples of the method, apparatuses, and non-transitory computer-readable medium described herein, receiving the indication of the resources of the configuration may include operations, features, means, or instructions for receiving the resources associated with an uplink reference signal for distance estimation, where transmitting the signals according to the indicated resources of the configuration includes transmitting the uplink reference signal on the indicated resources.

In some examples of the method, apparatuses, and non-transitory computer-readable medium described herein, the uplink reference signal includes a sounding reference signal (SRS), or a reference signal for the distance estimation that may be different from the SRS, or any combination thereof.

Some examples of the method, apparatuses, and non-transitory computer-readable medium described herein may further include operations, features, means, or instructions for receiving positioning signals from one or more satellites of a global navigation system, where transmitting the signals according to the indicated resources of the configuration includes transmitting an indication of positioning information for the wireless device that may be determined based on the received positioning signals.

In some examples of the method, apparatuses, and non-transitory computer-readable medium described herein, receiving the indication of the distance may include operations, features, means, or instructions for receiving a MAC-CE that includes the indication of the distance, a downlink control information (DCI) message that includes the indication of the distance, or any combination thereof.

A method for wireless communication at a network node is described. The method may include transmitting, to a wireless device, an indication of resources of a configuration for the wireless device to use to determine a distance between a first antenna array of the wireless device that includes a first set of multiple antenna elements and a second antenna array of the network node that includes a second set of multiple antenna elements, transmitting signals according to the indicated resources of the configuration, and receiving, from the wireless device, an indication of the distance that is based on the signals transmitted according to the configuration.

An apparatus for wireless communication at a network node is described. The apparatus may include a processor, memory coupled with the processor, and instructions stored in the memory. The instructions may be executable by the processor to cause the apparatus to transmit, to a wireless device, an indication of resources of a configuration for the wireless device to use to determine a distance between a first antenna array of the wireless device that includes a first set of multiple antenna elements and a second antenna array of the network node that includes a second set of multiple antenna elements, transmit signals according to the indicated resources of the configuration, and receive, from the wireless device, an indication of the distance that is based on the signals transmitted according to the configuration.

Another apparatus for wireless communication at a network node is described. The apparatus may include means for transmitting, to a wireless device, an indication of resources of a configuration for the wireless device to use to determine a distance between a first antenna array of the wireless device that includes a first set of multiple antenna elements and a second antenna array of the network node that includes a second set of multiple antenna elements, means for transmitting signals according to the indicated resources of the configuration, and means for receiving, from the wireless device, an indication of the distance that is based on the signals transmitted according to the configuration.

A non-transitory computer-readable medium storing code for wireless communication at a network node is described. The code may include instructions executable by a processor to transmit, to a wireless device, an indication of resources of a configuration for the wireless device to use to determine a distance between a first antenna array of the wireless device that includes a first set of multiple antenna elements and a second antenna array of the network node that includes a second set of multiple antenna elements, transmit signals according to the indicated resources of the configuration, and receive, from the wireless device, an indication of the distance that is based on the signals transmitted according to the configuration.

In some examples of the method, apparatuses, and non-transitory computer-readable medium described herein, receiving the indication of the distance may include operations, features, means, or instructions for receiving, from the wireless device, an indication of a signal strength value for the transmitted signals.

In some examples of the method, apparatuses, and non-transitory computer-readable medium described herein, receiving the indication of the distance may include operations, features, means, or instructions for receiving, from the wireless device, an indication of a distance value that may be determined by the wireless device.

In some examples of the method, apparatuses, and non-transitory computer-readable medium described herein, transmitting the signals according to the indicated resources may include operations, features, means, or instructions for transmitting CSI-RSs, the indication of the distance device based on the transmitted CSI-RSs.

In some examples of the method, apparatuses, and non-transitory computer-readable medium described herein, transmitting the signals according to the indicated resources may include operations, features, means, or instructions for transmitting second reference signals for determining the distance that may be different from a CSI-RS, the indication of the distance based on the transmitted second reference signals.

In some examples of the method, apparatuses, and non-transitory computer-readable medium described herein, transmitting the indication of the resources of the configuration may include operations, features, means, or instructions for transmitting the indication of resources for the wireless device to use to receive positioning signals from one or more satellites of a global navigation system, resources for the wireless device to use to receive PRSs from one or more base stations, or any combination thereof.

Some examples of the method, apparatuses, and non-transitory computer-readable medium described herein may further include operations, features, means, or instructions for transmitting a set of index values and a set of distance values, each index value of the set of index values corresponding to one of the set of distance values, where the indication of the distance received from the wireless device includes an index value selected from the set of index values.

A method for wireless communication at a network node is described. The method may include transmitting, to a wireless device, an indication of resources of a configuration for the wireless device to use to transmit signals to the network node; the signals for determining a distance between a first antenna array of the wireless device that includes a first set of multiple antenna elements and a second antenna array of the network node that includes a second set of multiple antenna elements, receiving signals from the wireless device according to the indicated resources of the configuration, and transmitting, to the wireless device, an indication of the distance determined by the network node based on the signals received from the wireless device according to the configuration.

An apparatus for wireless communication at a network node is described. The apparatus may include a processor, memory coupled with the processor, and instructions stored in the memory. The instructions may be executable by the processor to cause the apparatus to transmit, to a wireless device, an indication of resources of a configuration for the wireless device to use to transmit signals to the network node; the signals for determining a distance between a first antenna array of the wireless device that includes a first set of multiple antenna elements and a second antenna array of the network node that includes a second set of multiple antenna elements, receive signals from the wireless device according to the indicated resources of the configuration, and transmit, to the wireless device, an indication of the distance determined by the network node based on the signals received from the wireless device according to the configuration.

Another apparatus for wireless communication at a network node is described. The apparatus may include means for transmitting, to a wireless device, an indication of resources of a configuration for the wireless device to use to transmit signals to the network node; the signals for determining a distance between a first antenna array of the wireless device that includes a first set of multiple antenna elements and a second antenna array of the network node that includes a second set of multiple antenna elements, means for receiving signals from the wireless device according to the indicated resources of the configuration, and means for transmitting, to the wireless device, an indication of the distance determined by the network node based on the signals received from the wireless device according to the configuration.

A non-transitory computer-readable medium storing code for wireless communication at a network node is described. The code may include instructions executable by a processor to transmit, to a wireless device, an indication of resources of a configuration for the wireless device to use to transmit signals to the network node; the signals for determining a distance between a first antenna array of the wireless device that includes a first set of multiple antenna elements and a second antenna array of the network node that includes a second set of multiple antenna elements, receive signals from the wireless device according to the indicated resources of the configuration, and transmit, to the wireless device, an indication of the distance determined by the network node based on the signals received from the wireless device according to the configuration.

In some examples of the method, apparatuses, and non-transitory computer-readable medium described herein, receiving the signals according to the indicated resources of the configuration may include operations, features, means, or instructions for receiving a power headroom report that includes an indication of a pathloss associated with communications between the wireless device and the network node.

In some examples of the method, apparatuses, and non-transitory computer-readable medium described herein, transmitting the indication of the resources of the configuration may include operations, features, means, or instructions for transmitting the resources associated with an uplink reference signal for distance estimation for the wireless device to use to transit to the network node, where the received signals include the uplink reference signal.

In some examples of the method, apparatuses, and non-transitory computer-readable medium described herein, the uplink reference signal includes an SRS, or a reference signal for distance estimation that may be different from the SRS, or any combination thereof.

Some examples of the method, apparatuses, and non-transitory computer-readable medium described herein may further include operations, features, means, or instructions for receiving positioning signals from one or more satellites of a global navigation system, where transmitting signals according to the indicated resources of the configuration includes transmitting an indication of positioning information for the wireless device that may be determined based on the received positioning signals.

### BRIEF DESCRIPTION OF THE DRAWINGS

FIGS. 1 and 2 illustrate examples of wireless communications systems that support signaling aspects of distance estimation for line of sight (LOS) multiple input multiple output (MIMO) communications in accordance with aspects of the present disclosure.

FIGS. 3 and 4 illustrate examples of process flows that support signaling aspects of distance estimation for LOS MIMO communications in accordance with aspects of the present disclosure.

FIGS. 5 and 6 show block diagrams of devices that support signaling aspects of distance estimation for LOS MIMO communications in accordance with aspects of the present disclosure.

FIG. 7 shows a block diagram of a communications manager that supports signaling aspects of distance estimation for LOS MIMO communications in accordance with aspects of the present disclosure.

FIG. 8 shows a diagram of a system including a device that supports signaling aspects of distance estimation for LOS MIMO communications in accordance with aspects of the present disclosure.

FIGS. 9 and 10 show block diagrams of devices that support signaling aspects of distance estimation for LOS MIMO communications in accordance with aspects of the present disclosure.

FIG. 11 shows a block diagram of a communications manager that supports signaling aspects of distance estimation for LOS MIMO communications in accordance with aspects of the present disclosure.

FIG. 12 shows a diagram of a system including a device that supports signaling aspects of distance estimation for LOS MIMO communications in accordance with aspects of the present disclosure.

FIGS. 13 through 16 show flowcharts illustrating methods that support signaling aspects of distance estimation for LOS MIMO communications in accordance with aspects of the present disclosure.

### DETAILED DESCRIPTION

In some examples, the structure of a line of sight (LOS) channel may be exploited to achieve high multiplexing gain. For example, multiplexing gain of an LOS multiple input multiple output (MIMO) channel may depend on an antenna separation as well as a distance between a transmitting and receiving array. In some examples a LOS channel may be deterministic and may be computed based on an antenna configuration and a distance between communicating antennas. Channel estimation sensitivity to errors in distance feedback may be relatively small. That is, communication performance may not be sensitive to distance feedback error. For example, for distance error up to 500λ, where λ is a wavelength of a communications channel, there may be reasonable, or acceptable, performance.

In some examples, a user equipment (UE) may be configured to estimate the distance between a receiving and a transmitting antenna and may report the distance estimate back to a base station. In some cases, the UE may estimate the distance between the antennas from path loss using an reference signal received power (RSRP) measurement (e.g., as well as antenna gain, penetration loss, transmission power) to estimate the channel. In such examples, the UE may report the measurement information back to the base station. That is, the UE may transmit a measurement report to the base station including information associated with estimating the channel. In some examples, the UE may report back the RSRP measurement to the base station, where the UE may transmit the measurement report including the RSRP measurement. In other examples, the UE may report back a distance measurement to the base station, where the UE may estimate the distance between the antenna at the UE and the antenna at the base station and may transmit the measurement report, to the base station, including the distance estimate.

In some examples, the base station may be configured to estimate the distance between a receiving and a transmitting antenna and may report the distance estimate back to the UE. That is, the base station may estimate the distance between the antenna at the UE and the antenna at the base station and feedback the distance estimate back to the UE. In some cases, the base station may estimate the distance between the antennas using pathloss obtained from a power headroom report (PHR). That is, in some cases, the UE may transmit the PHR to the base station including a path loss, where the base station may obtain the path loss and may estimate the distance between antennas based thereon.

Aspects of the disclosure are initially described in the context of wireless communications systems. Aspects of the disclosure are then described in the context of process flows. Aspects of the disclosure are further illustrated by and described with reference to apparatus diagrams, system diagrams, and flowcharts that relate to signaling aspects of distance estimation for LOS MIMO communications.

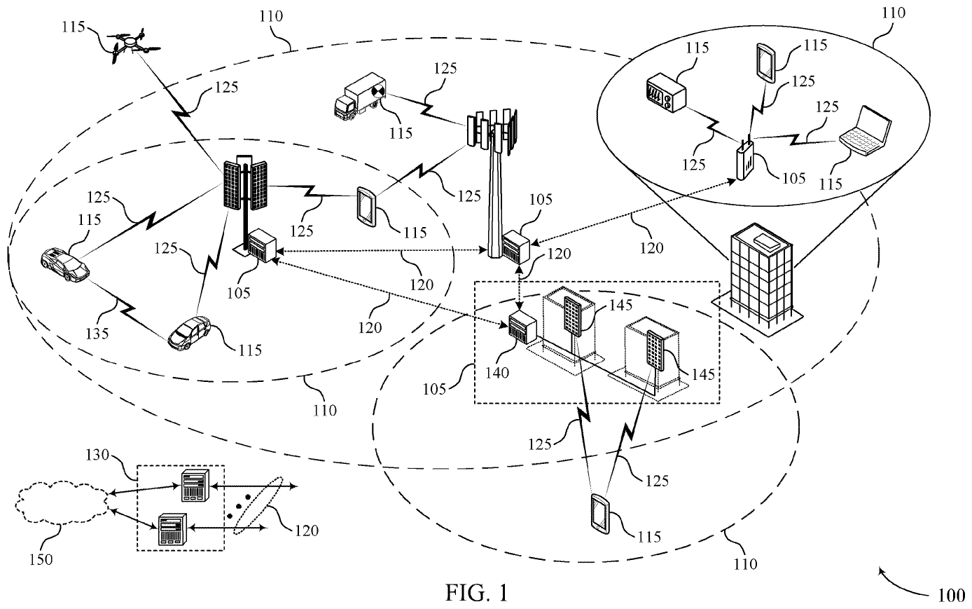

FIG. 1 illustrates an example of a wireless communications system 100 that supports signaling aspects of distance estimation for LOS MIMO communications in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHZ, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Media Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, the structure of a line of sight (LOS) channel may be exploited to achieve high multiplexing gain. For example, multiplexing gain of an LOS multiple input multiple output (MIMO) channel may depend on an antenna separation as well as a distance between a transmitting and receiving array. In some examples a completely LOS channel may be deterministic and may be computed using an antenna configuration and a distance between communicating antennas. Channel estimation sensitivity to errors in distance feedback may be relatively small. That is, communication performance may not be sensitive to distance feedback error. For example, for distance error up to 500λ, where λ is a wavelength of a communications channel, there may be reasonable, or acceptable, performance. For example, at 3 GHZ, 500λ may be five meters and at 30 GHz, 500λ may be 50 cm. In some cases, 10 s of cm of error in distance feedback may be tolerated for completely LOS channels. With reference to the previous example, an error of 500λ at 30 GHz may be tolerated for a completely LOS channel.

In some examples, a UE 115 may be configured to estimate the distance between a receiving and a transmitting antenna and may report the distance estimate back to a base station 105. In some cases, the UE 115 may estimate the distance between the antennas from path loss using an RSRP measurement (e.g., as well as antenna gain, penetration loss, transmission power) to estimate the channel. In such examples, the UE 115 may report the measurement information back to the base station 105. That is, the UE 115 may transmit a measurement report to the base station 105 including information associated with estimating the channel. In some examples, the UE 115 may report back the RSRP measurement to the base station 105, where the UE 115 may transmit the measurement report including the RSRP measurement. In other examples, the UE 115 may report back a distance measurement to the base station 105, where the UE 115 may estimate the distance between the antenna at the UE 115 and the antenna at the base station 105 and may transmit the measurement report, to the base station 105, including the distance estimate.

In some examples, the base station 105 may be configured to estimate the distance between a receiving and a transmitting antenna and may report the distance estimate back to the UE 115. That is, the base station 105 may estimate the distance between the antenna at the UE 115 and the antenna at the base station 105 and feedback the distance estimate back to the UE 115. In some cases, the base station 105 may estimate the distance between the antennas using pathloss obtained from a PHR report. That is, in some cases, the UE 115 may transmit a PHR report to the base station 105 including a path loss, where the base station 105 may obtain the path loss and may estimate the distance between antennas based thereon.

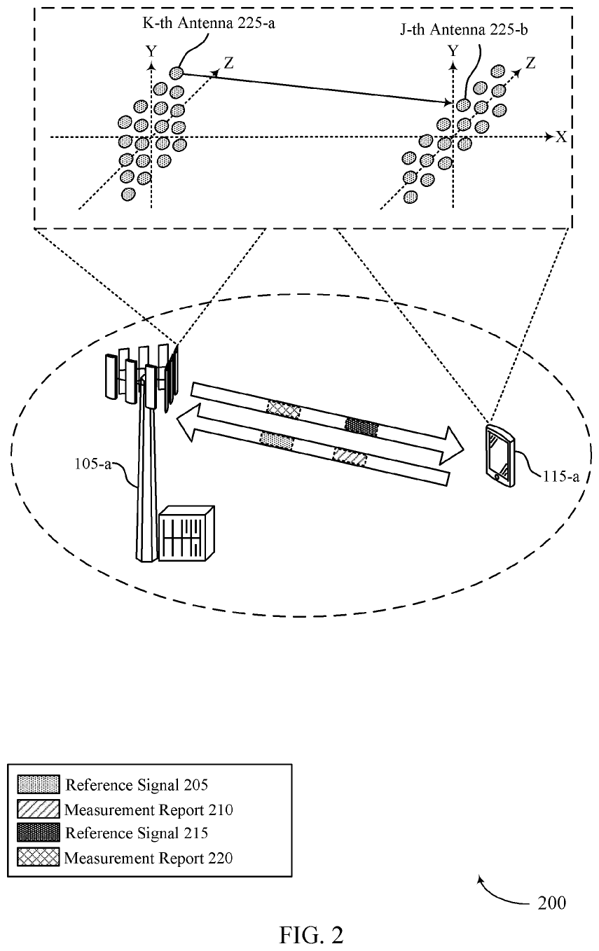

FIG. 2 illustrates an example of a wireless communications system 200 that supports signaling aspects of distance estimation for LOS MIMO communications in accordance with aspects of the present disclosure. The wireless communications system 200 may implement or be implemented by aspects of the wireless communications system 100. For example, wireless communications system 200 may include a base station 105-a and a UE 115-a which may be examples of corresponding devices as described with reference to FIG. 1. In some examples, the UE 115-a and the base station 105-a may exchange signaling supporting antenna realignment at the UE 115-a, the base station 105-a or both.

Some wireless communications systems, such as wireless communications system 200, may support LOS MIMO. In some examples, LOS MIMO may provide high multiplexing gain with the satisfaction of one or more conditions. For example, LOS MIMO may provide high multiplexing gain in cases where a distance between a transmitting antenna and a receiving antenna fails to exceed a threshold, where the threshold may depend on apertures of the transmitting antenna, the receiving antenna, a carrier frequency, or a combination thereof. Phrased alternatively LOS MIMO may provide high multiplexing gain in cases where the transmitting antenna and the receiving antenna are relatively close (e.g., as compared to a distance threshold based on antenna apertures and a carrier frequency). In some examples, LOS MIMO may provide high multiplexing gain in cases where devices use accurate LOS MIMO precoders. For example, a transmitting device may acquire channel knowledge (e.g., channel conditions, channel quality) and may generate an LOS MIMO precoder based thereon. Additionally or alternatively, communicating devices may feedback distance information to one another and may perform misalignment compensation based thereon, for example, by generating an accurate LOS MIMO precoder.

There are multiple deployment scenarios where wireless communications systems perform LOS MIMO differently. For example, LOS MIMO may be performed in a backhaul link between a network node (e.g., a gNB, an IAB node, a sidelink UE 115) and a relay (e.g., an IAB node, a smart repeater, a CPE, drones). In another example, LOS MIMO may be performed in an access link between a network node (or relay) and a UE 115.

In some examples, wireless devices may estimate communications channels (e.g., for LOS spatial multiplexing (LSM), M-MIMO) in accordance with a channel model. For example, wireless devices may estimate communications channels in accordance with a Rician channel model. That is, Equation 1 may be used to estimate communications channels.

$$H = {aH}_{LOS} + {bH}_{NLOS} \qquad ( 1 )$$

In Equation 1, H_{LOS} may represent an LOS channel metric, and may be equal to

$${H}_{LOS} = \frac{exp ( - i 2 π \frac{{r}_{jk}}{λ} )}{\frac{{r}_{jk}}{λ}} ,$$

where rⱼₖ may be a distance between a transmitter antenna and a receiver antenna and A may be a wavelength of a carrier frequency. For example, H_{LOS} may be associated with the LOS channel metric between a k-th antenna 225-a and a j-th antenna 225-b. In some examples, Hⱼₖ may be a channel metric between the k-th antenna 225-a and the j-th antenna 225-b and may be represented by

$${H}_{jk} \sim C \frac{exp ( - i 2 π \frac{{r}_{jk}}{λ} )}{\frac{{r}_{jk}}{λ}} ,$$

where C may be a proportionality constant. In such examples, Hⱼₖ may be constructed in accordance with distance (e.g., rⱼₖ) feedback, a transmitting and receiving antenna 225 configuration, or a combination thereof, and Hⱼₖ may produce a singular value decomposition (SVD) LOS precoder. The value for r may be a function of the wavelength λ and a distance d between the transmitter antenna and the receiver antenna (e.g., r=λd). In some examples, H_{NLOS} may represent an non-LOS (NLOS) channel metric and may be determined by a Raleigh distribution, a clustered delay line (CDL), a tapped delay line (TDL), or a combination thereof. In some examples, a and b are weight factors associated with the channel being composed of an LOS component and an NLOS component, respectively. For example, a²+b²=1, where a² may be a percentage of the channel being composed of LOS communications. In some cases, LSM and M-MIMO may be compared at least in accordance with Equation 1 and referencing Table 1.

TABLE 1

| | LSM | M-MIMO |
|---|---|---|
| Antenna | Circular, 1D, 2D | 1D, 2D |
| Arrays | | |
| Channel | Strong LOS Component | Weak LOS Component |
| Matrix | (a >> b) | (a << b) |
| SVD-based | Implicit, benefitting from | Explicit, CSF may be used at |
| Precoder | the special structure of | the transmitter side to |
| | channel (e.g., limited, no | compute SVD |
| | joint caching and downlink | |
| | resource sharing | |
| | optimization framework | |
| | (CSF)) | |

In Table 1, the antenna arrays row represents the different types of antenna arrays that may be used for LSM and M-MIMO. Further, the channel matrix row represents the dominating weight factor in Equation 1 that may aid a wireless device in determining whether to use LSM or M-MIMO. For example, in cases where there is a strong LOS component, a wireless device may determine to use LSM. In some cases, LSM and M-MIMO may differ in an SVD precoder, where determining a precoder may be implicit in cases where devices use LSM and explicit in cases where devices use M-MIMO.

In some examples, the structure of an LOS MIMO channel may be exploited to achieve high multiplexing gain. For example, multiplexing gain of an LOS MIMO channel may depend on an antenna separation as well as a distance between a transmitting and receiving array. Further, enhanced performance may be captured in cases where transmitting and receiving arrays are aligned. That is, antenna array misalignment may result in relatively poor signal quality as compared to a signal quality associated with perfectly aligned antennas.

In some examples a completely LOS channel (e.g., 100% LOS channel) may be deterministic and may be computed using an antenna figuration and a distance between communicating antennas. For example, the base station 105-a may be aware of an antenna configuration at the UE 115-a (e.g., a type of antenna geometry such as uniform circular arrays (UCA), uniform linear arrays (ULA), uniform rectangular arrays (URA), a number of antennas 225, an antenna spacing, an antenna polarization) as well as a distance between the antenna array at the base station 105-a and the antenna array at the UE 115-a. In such examples, the base station 105-a may be able to compute the LOS channel. Instead of estimating and feeding back channel coefficients between transmitting and receiving antenna pairs, distance estimation may be easier to determine and may, in some cases, reduce feedback overhead. In relatively strong LOS channels (e.g., where LOS communications is more abundant than NLOS communications), a strong correlation may exist between antenna pairs which may be dependent on a distance between the transmitting and receiving arrays. In such cases, distance feedback may be used to reduce channel estimation overhead as such information may help to construct the LOS component of the channel metric. Additionally, fine tuning for fading components may be used in cases where the channel is not completely LOS. For example, in such examples, the base station 105-a may transmit demodulation reference signal (DMRS) to the UE 115-a for fine channel tuning occasionally (e.g., sparsely).

Channel estimation sensitivity to errors in distance feedback may be relatively small. That is, communication performance may not be sensitive to distance feedback error. For example, for distance error up to 500λ, where λ is a wavelength of a communications channel, there may be reasonable, or acceptable, performance. For example, at 3 GHz, 500λ may be five meters and at 30 GHz, 500λ may be 50 cm. In some cases, 10s of cm of error in distance feedback may be tolerated for completely LOS channels. With reference to the previous example, an error of 500λ at 30 GHz may be tolerated for a completely LOS channel.

In some examples, the UE 115-a (or a relay) may be configured to estimate the distance between a receiving and a transmitting antenna 225 and may report the distance estimate back to the base station 105-a (e.g., a network node). That is, the UE 115-a may estimate the distance between the antenna 225-b and the antenna 225-a and feedback the distance estimate back to the base station 105-a. In some cases, the UE 115-a may estimate the distance between the antennas 225 from path loss using an RSRP measurement (e.g., as well as antenna gain, penetration loss, transmission power) to estimate the channel. In some examples, fields may be added to RRC configuration including a configuration for network node antenna gain. That is, the base station 105-a may signal the network node antenna gain to the UE 115-a, where the UE 115-a may use the network node antenna gain to compute the path loss, the distance between the antennas 225, and the channel estimate. Additionally, the UE 115-a may be configured with a penetration loss (e.g., in RRC signaling) which the UE 115-a may use to calculate the path loss. In such examples, the UE 115-a may report the measurement information back to the network node. That is, the UE 115-a may transmit measurement report 210 to the base station 105-a including information associated with estimating the channel. In some examples, the UE 115-a may report back the RSRP measurement to the base station 105-a, where the UE 115-a may transmit the measurement report 210 including the RSRP measurement. In other examples, the UE 115-a may report back a distance measurement to the base station 105-a, where the UE 115-a may estimate the distance between the antenna 225-b and the antenna 225-a and may transmit the measurement report 210, to the base station, including the distance estimate.

In some examples, the network node may transmit a downlink reference signal from which the UE 115-a may estimate the distance between antennas 225 and report back to the network node. That is, the base station 105-a may transmit reference signal 215 to the UE 115-a, where the UE 115-a may measure the reference signal 215 and transmit measurement report 210 back to the base station 105-a. In some examples, the reference signal 215 may be a CSI-RS for distance estimation, for example, reusing an existing configuration field for an LOS mode (e.g., a “channel measurement” field reused for distance estimation). In other examples, the reference signal 215 may be a reference signal specifically defined for the LOS mode. For example, the base station 105-a may transmit the reference signal 215 as an LOS-RS, where the UE 115-a may measure the LOS-RS and may report back a distance estimate back to the base station 105-a (e.g., in measurement report 210). In some examples, the UE 115-a may estimate the distance between the antennas 225 using positioning information. For example, the UE 115-a may use global positioning system (GPS) information to assist the distance estimation between the antenna 225-b and the antenna 225-a.

In some examples, the UE 115-a may estimate the distance between the antenna 225-a and the antenna 225-b based on one or more positioning reference signals (PRSs) (e.g., from base stations 105, in some cases, including base station 105-a). For example, the base station 105-a may transmit the reference signal 215 as a downlink PRS, where the UE 115-a may receive the reference signal 215 and one or more other downlink PRSs from one or more other base stations 105. In such examples, the UE 115-a may estimate the position of the UE 115-a, for example, with reference to one or more base stations 105. In some cases, the UE 115-a may use such positioning information to estimate the distance between the antenna 225-b and the antenna 225-a. In some examples the downlink PRS may be configured periodically, where after a certain period of time, the base station 105-a and the one or more other base stations 105 may transmit downlink PRS to the UE 115-a supporting the antenna distance estimation at the UE 115-a. In such examples, the UE 115-a may report back measurement report 210 based on a timer, a threshold, or the like. For example, the UE 115-a may transmit the measurement report 210 periodically (e.g., in accordance with a periodicity of the downlink PRSs). In some examples, the downlink PRSs may be configured based on a timer or a certain threshold associated with a difference in two distance estimations (e.g., last two distance estimations). For example, the UE 115-a may receive downlink PRSs each time a timer expires, until a timer expires, among other downlink PRS configurations associated with a timer. In another example, the UE 115-a may estimate a first position in accordance with a first downlink PRS instance (e.g., where the UE 115-a receives the one or more downlink PRSs) and the UE 115-a may estimate a second position in accordance with a second downlink PRS instance. In cases where the distance between the first position and the second position satisfies a distance threshold, the UE 115-a may trigger a third PRS instance.

The UE 115-a may transmit the measurement report 210 in accordance with a report back (e.g., to the network node) mechanism. For example, the UE 115-a may transmit the measurement report 210 including an indication pointing to an RRC configured table (e.g., up to a certain granularity such as an N-bit floating point representation) associated with reporting distance information. In some examples, the UE 115-a may transmit the measurement report 210 as a CSI report and may reuse existing fields in the CSI report to indicate the distance estimate to the base station 105-a. For example, the UE 115-a may reuse the bit fields CQI, PMI, RI, among other fields in the CSI report to indicate the distance estimate to the base station 105-a. In some examples, the UE 115-a may transmit the measurement report 210 as a layer 2 (L2) report. For example, the UE 115-a may transmit the measurement report 210 as a UL LOS MAC CE, triggered based on a timer or a certain threshold associated with a difference in two distance estimations (e.g., triggered when a distance estimation changes by five percent or more). In some examples, the UE 115-a may transmit the measurement report 210 as a layer one (L1) report. For example, the UE 115-a may transmit the measurement report 210 as an LOS CSI report for distance and in accordance with a specific triggering mechanism (e.g., triggered by MAC CE or downlink control information (DCI)). In some examples, the UE may transmit the measurement report 210 as a layer 3 (L3) report. For example, the UE 115-a may transmit the measurement report 210 including the measurements (e.g., a measured RSRP, a pathloss).

In some examples, the base station 105-a (or network node) may be configured to estimate the distance between a receiving and a transmitting antenna 225 and may report the distance estimate back to the UE 115-a. That is, the base station 105-a may estimate the distance between the antenna 225-b and the antenna 225-a and feedback the distance estimate back to the UE 115-a. In some cases, the base station 105-a may estimate the distance between the antennas 225 using pathloss obtained from a PHR report. That is, in some cases, the UE 115-a may transmit a PHR report to the base station 105-a indicating a path loss, where the base station 105-a may obtain the path loss and may estimate the distance between antennas 225 based thereon.

In some examples, the network node may request an uplink reference signal from the UE 115-a to estimate the distance between the antennas. That is, the base station 105-a may request reference signal 205 from the UE 115-a, where the base station 105-a may measure the reference signal 205 and transmit measurement report 220 back to the UE 115-a. In some examples, the reference signal 205 may be a sounding reference signal (SRS) for distance estimation (e.g., xTIR SRS may be used), for example, reusing an existing configuration field for an LOS mode (e.g., a “beam management” or a “codebook based” field reused for distance estimation). In other examples, the reference signal 205 may be a reference signal specifically defined for the LOS mode. For example, the base station 105-a may request the reference signal 205 as an LOS-RS, where the base station 105-a may measure the LOS-RS and may report back a distance estimate back to the UE 115-a (e.g., in measurement report 220). In some examples, the base station 105-a may estimate the distance between the antennas 225 using positioning information. For example, the UE 115-a may transmit a feedback message indicating geolocation information (e.g., GPS information, united air interface (UAI), etc.) to assist the base station 105-a in estimating distance between the antenna 225-b and the antenna 225-a.

In some examples, estimation may occur at a network node (e.g., the base station 105-b) and the network node may indicate the estimation to the UE 115-a (or a relay). In some examples, the base station 105-a may transmit the measurement report 220 as a downlink LOS MAC CE indicating one of multiple RRC configured entries in a table associated with reporting distance estimations. That is, the base station 105-a may configure the UE 115-a with a set of index values corresponding to respective distance estimate values, for example, in a table, where the base station 105-a may transmit a downlink LOS MAC CE indicating one of the index values associated with a distance value to report a distance estimate to the UE 115-a. In some cases, the base station 105-a may transmit the measurement report 220 based on a timer or a certain threshold associated with a difference in two distance estimations (e.g., the last two distance estimations). For example, the base station 105-a may transmit the measurement report 220 each time a timer expires, until a timer expires, among other reporting mechanisms associated with a timer. In another example, the base station 105-a may estimate a first position in accordance with a first SRS instance (e.g., where the UE 115-a transmits an SRS to the base station 105-a) and the base station 105-a may estimate a second position in accordance with a second SRS instance. In cases where the distance between the first position and the second position satisfies a distance threshold, the base station 105-a may transmit the measurement report 220. In some examples, the base station 105-a may transmit the measurement report 220 as a GC-DCI (e.g., in a field including a bitmap or pointing to a table of values) to indicate a distance estimate (e.g., LSM for low mobility scenarios) to the UE. For example, for each block within a DCI format 2_3, the base station 105-a may add N bits to include distance feedback information. In such cases, the UE 115-a may be configured in advance for the inclusion of distance feedback in the DCI. In some examples, the base station 105-a may use an N-bit floating point representation (e.g., N=16) for distance feedback. For example, the base station 105-a may transmit the measurement report 220 to the UE 115-a including the N-bit floating point representation to indicate the distance between the antenna 225-a and the antenna 225-b.

Configuring wireless devices to perform antenna 225 distance estimation and feedback may result in higher quality communications, enhanced coordination between devices, greater transmission throughput, and reduced signal overhead associated with channel metric feedback.

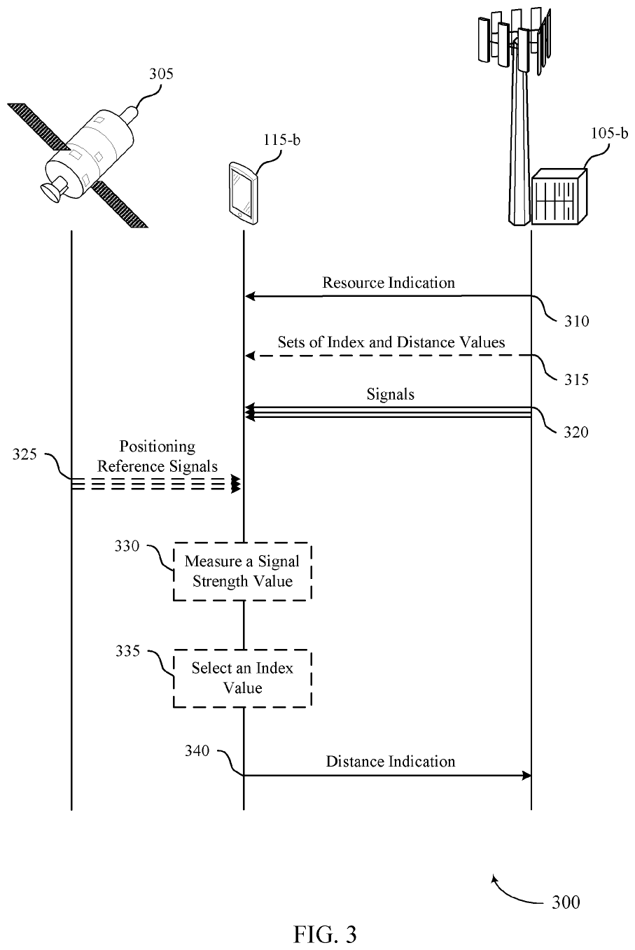

FIG. 3 illustrates an example of a process flow 300 that supports signaling aspects of distance estimation for LOS MIMO communications in accordance with aspects of the present disclosure. In some examples, the process flow 300 may implement aspects of wireless communications systems 100 or 200. For example, process flow 300 may include UE 115-b (or a relay node) and base station 105-b, which may be examples of corresponding devices as described with reference to FIGS. 1 and 2. In some examples, the process flow 300 may include a satellite 305 which may be an example of a non-terrestrial base station 105, a non-terrestrial relay node, among other examples of satellites 305. In some examples, the UE 115-b and the base station 105-b to perform a distance estimation procedure to estimate a channel metric between the UE 115-b, the base station 105-b, or both.

In the following description of the process flow 300, the operations may be performed (e.g., reported or provided) in a different order than the order shown, or the operations performed by the UE 115-b, the base station 105-b, and the satellite 305 may be performed in different orders or at different times. For example, specific operations also may be left out of the process flow 300, or other operations may be added to the process flow 300. Further, although some operations or signaling may be shown to occur at different times for discussion purposes, these operations may actually occur at the same time.

At 310, the base station 105-b may transmit, and the UE 115-b may receive an indication of resource of a configuration for the UE 115-b to use to determine a distance between a first antenna array of the UE 115-b that includes a first plurality of antenna elements and a second antenna array of a network node (e.g., the base station 105-b) that includes a second plurality of antenna elements. That is, the UE 115-b may receive a resource indication including resources for a configuration for the UE 115-b to use to determine the distance between an antenna at the UE 115-b and an antenna at the base station 105-b. For example, the UE 115-b may receive a resource indication including resources (e.g., time resources such as one or more symbol periods, one or more slots, etc., frequency resources such as one or more resource elements, one or more resource blocks, one or more frequency bands, or any combination thereof) for the UE 115-b to receive one or more reference signals associated with distance estimation at the UE 115-b, for the UE 115-b to transmit one or more reference signals associated with distance estimation at the base station 105-b, or a combination thereof. In some cases, receiving the indication of the resources of the configuration may include receiving an indication of a period associated with reporting a distance indication. Additionally or alternatively, receiving the indication of the resources of the configuration may include receiving an indication of at least one of a timer value or a threshold value for a difference between distances between the first antenna array and the second antenna array, where the UE 115-b may transmit a distance indication to the base station 105-b according to the indication of the at least one of the timer value or the threshold value.

In some examples, at 315, the base station 105-b may transmit, and the UE 115-b may receive a set of index values and a set of distance values, each index value of the set of index values corresponding to one of the set of distance values, for example, such as the set of index values as described with reference to FIG. 2.

At 320, the base station 105-b may transmit, and the UE 115-b may receive signals according to the indicated resources of the configuration. In some cases, receiving the signals according to the indicated resources includes receiving CSI-RSs, where the UE 115-b may determine the distance between the UE 115-b and the base station 105-b based at least in part on the received CSI-RSs (e.g., performing a measurement on the CSI-RSs). In some examples, receiving the signals according to the indicated resources includes receiving second reference signals for determining the distance that are different from a CSI-RS, where the UE 115-b may determine the distance based at least in part on the received second reference signals. For example, the second reference signals may be examples of LOS-RSs as described with reference to FIG. 2. In some cases, such as at 325, the signals may include PRSs received from one or more satellites (e.g., satellite 305) of a global navigation system (e.g., GPS). Alternatively, or additionally, the signals may include PRSs received from the base station 105-b.

In some examples, at 330, the UE 115-b may measure a signal strength value (e.g., an RSRP) of the one or more signals received at 320, where the UE 115-b may estimate the distance between the antenna panels of the UE 115-b and the base station 105-b based on the signal strength value.

In some examples, at 335, the UE 115-b may select, from the set of index values based at least in part on the signals received according to the configuration, an index value corresponding to the distance.

At 340, the UE 115-b may transmit, and the base station 105-b may receive, and indication of the distance that is based at least in part on the signals received according to the configuration. In some examples, the UE 115-b may transmit the indication of the distance including transmitting, to the base station 105-b, an indication of the signal strength value for the received signals that is determined by the UE 115-b. In some cases, transmitting the indication of the distance may include transmitting, to the base station 105-b, an indication of a distance value that is determined by the UE 115-b based at least in part on a signal strength for the received signals. In examples where the received signals include PRSs from one or more satellites of a global navigation system, transmitting the indication of the distance may include transmitting positioning information for the UE 115-b that is based at least in part on the received positioning signals. In examples where the received signals include PRSs received from one or more base stations 105, transmitting the indication of the distance may include transmitting positioning information for the UE 115-b that is based at least in part on the received PRSs. In cases where the UE 115-b selects an index value corresponding to the distance, the selected index value may be the indication of the distance. In such cases, the selected index value may be transmitted as at least a portion of a CSI report, an uplink LOS MAC CE, a second MAC CE different from the uplink LOS MAC CE, a measurement report, or a combination thereof.

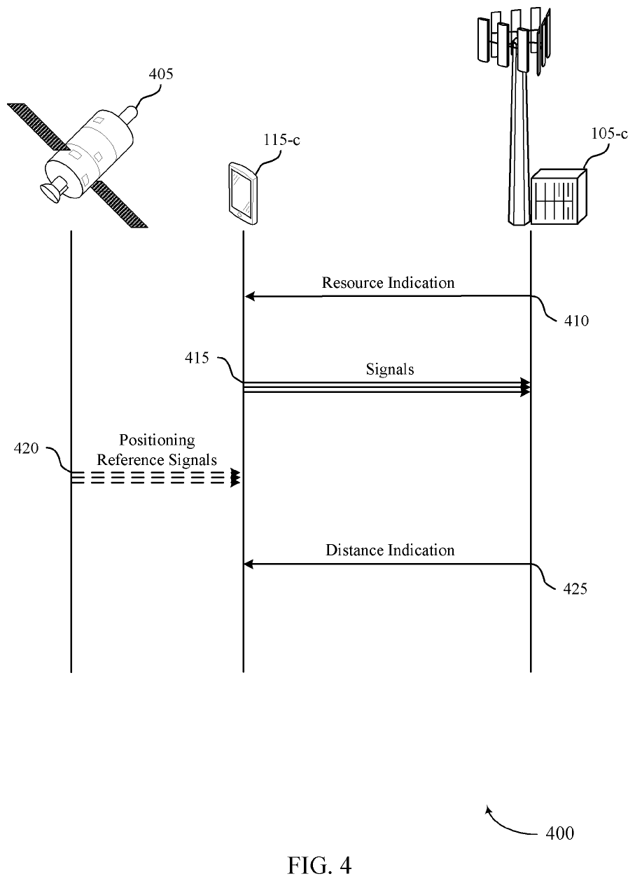

FIG. 4 illustrates an example of a process flow 400 that supports signaling aspects of distance estimation for LOS MIMO communications in accordance with aspects of the present disclosure. In some examples, the process flow 400 may implement aspects of wireless communications systems 100 or 200. For example, process flow 400 may include UE 115-c (or a relay node) and base station 105-c, which may be examples of corresponding devices as described with reference to FIGS. 1 and 2. In some examples, the process flow 400 may include a satellite 405 which may be an example of a non-terrestrial base station 105, a non-terrestrial relay node, among other examples of satellites 405. In some examples, the UE 115-c and the base station 105-c to perform a distance estimation procedure to estimate a channel metric between the UE 115-c, the base station 105-c, or both.

In the following description of the process flow 400, the operations may be performed (e.g., reported or provided) in a different order than the order shown, or the operations performed by the UE 115-c, the base station 105-c, and the satellite 405 may be performed in different orders or at different times. For example, specific operations also may be left out of the process flow 400, or other operations may be added to the process flow 400. Further, although some operations or signaling may be shown to occur at different times for discussion purposes, these operations may actually occur at the same time.

At 410, the base station 105-c may transmit, and the UE 115-c may receive an indication of resource of a configuration for the UE 115-c to use to determine a distance between a first antenna array of the UE 115-c that includes a first plurality of antenna elements and a second antenna array of a network node (e.g., the base station 105-c) that includes a second plurality of antenna elements. That is, the UE 115-c may receive a resource indication including resources for a configuration for the UE 115-c to use to determine the distance between an antenna at the UE 115-c and an antenna at the base station 105-c. In some examples, receiving the indication of the resources of the configuration may include receiving the resources associated with an uplink reference signal for distance estimation. The uplink reference signal may include an SRS, or a reference signal for the distance estimation that is different from the SRS (e.g., an LOS-RS), or a combination thereof.

At 415, the UE 115-c may transmit, and the base station 105-c may receive signals according to the indicated resources of the configuration. In some examples, transmitting the signals according to the indicated resources of the configuration may include transmitting a PHR that includes an indication of a pathloss associated with communications between the UE 115-c and the base station 105-c.

In some examples, at 420, the UE 115-c may receive positioning signals from one or more satellites of a global navigation system, where transmitting the signals according to the indicated resources of the configuration includes transmitting an indication of positioning information for the UE 115-c that is determined based at least in part on the received positioning signals.

At 425, the UE 115-c may receive, from the base station 105-c, an indication of the distance that is based at least in part on the signals transmitted according to the configuration. In some examples, receiving the indication of the distance includes receiving a MAC CE that includes the indication of the distance, a DCI message that includes the indication of the distance, or a combination thereof.

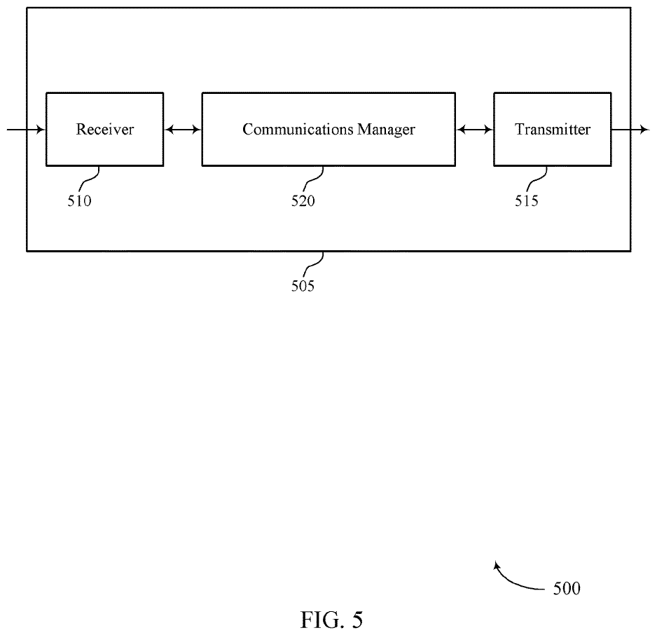

FIG. 5 shows a block diagram 500 of a device 505 that supports signaling aspects of distance estimation for LOS MIMO communications in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to signaling aspects of distance estimation for LOS MIMO communications). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to signaling aspects of distance estimation for LOS MIMO communications). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of signaling aspects of distance estimation for LOS MIMO communications as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

For example, the communications manager 520 may be configured as or otherwise support a means for receiving an indication of resources of a configuration for the wireless device to use to determine a distance between a first antenna array of the wireless device that includes a first set of multiple antenna elements and a second antenna array of a network node that includes a second set of multiple antenna elements. The communications manager 520 may be configured as or otherwise support a means for receiving signals according to the indicated resources of the configuration. The communications manager 520 may be configured as or otherwise support a means for transmitting, to the network node, an indication of the distance that is based on the signals received according to the configuration.

Additionally or alternatively, the communications manager 520 may support wireless communication at a wireless device in accordance with examples as disclosed herein. For example, the communications manager 520 may be configured as or otherwise support a means for receiving, from a network node, an indication of resources of a configuration for the wireless device to use to transmit signals to the network node, the signals associated with the network node determining a distance between a first antenna array of the wireless device that includes a first set of multiple antenna elements and a second antenna array of the network node that includes a second set of multiple antenna elements. The communications manager 520 may be configured as or otherwise support a means for transmitting signals according to the indicated resources of the configuration. The communications manager 520 may be configured as or otherwise support a means for receiving, from the network node, an indication of the distance that is based on the signals transmitted according to the configuration.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for communicating distance information for channel estimation procedures, resulting in reduced processing, reduced power consumption, and more efficient utilization of communication resources.

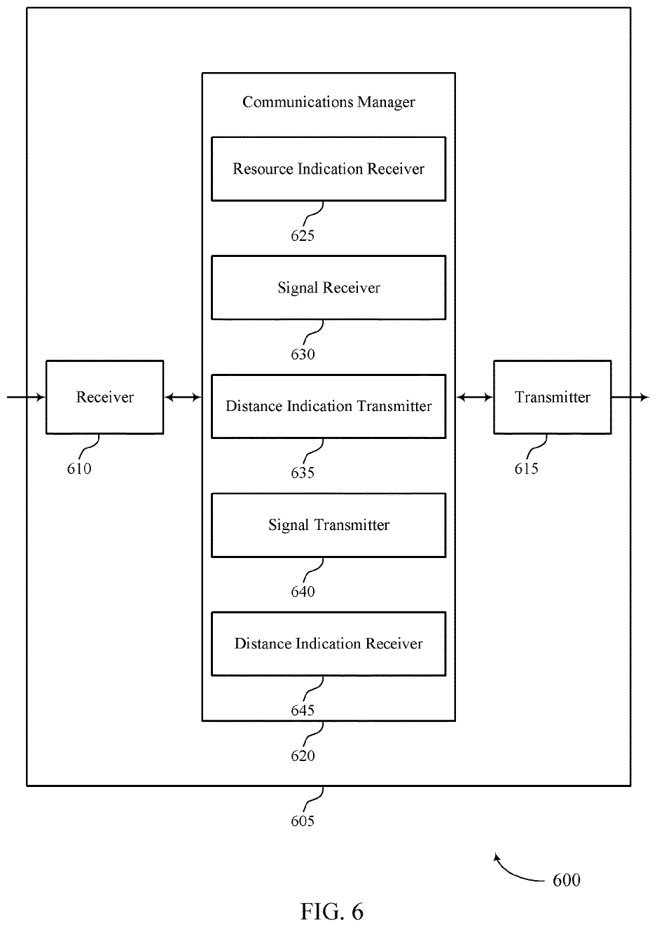

FIG. 6 shows a block diagram 600 of a device 605 that supports signaling aspects of distance estimation for LOS MIMO communications in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to signaling aspects of distance estimation for LOS MIMO communications). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to signaling aspects of distance estimation for LOS MIMO communications). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of signaling aspects of distance estimation for LOS MIMO communications as described herein. For example, the communications manager 620 may include a resource indication receiver 625, a signal receiver 630, a distance indication transmitter 635, a signal transmitter 640, a distance indication receiver 645, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The resource indication receiver 625 may be configured as or otherwise support a means for receiving an indication of resources of a configuration for the wireless device to use to determine a distance between a first antenna array of the wireless device that includes a first set of multiple antenna elements and a second antenna array of a network node that includes a second set of multiple antenna elements. The signal receiver 630 may be configured as or otherwise support a means for receiving signals according to the indicated resources of the configuration. The distance indication transmitter 635 may be configured as or otherwise support a means for transmitting, to the network node, an indication of the distance that is based on the signals received according to the configuration.

Additionally or alternatively, the communications manager 620 may support wireless communication at a wireless device in accordance with examples as disclosed herein. The resource indication receiver 625 may be configured as or otherwise support a means for receiving, from a network node, an indication of resources of a configuration for the wireless device to use to transmit signals to the network node, the signals associated with the network node determining a distance between a first antenna array of the wireless device that includes a first set of multiple antenna elements and a second antenna array of the network node that includes a second set of multiple antenna elements. The signal transmitter 640 may be configured as or otherwise support a means for transmitting signals according to the indicated resources of the configuration. The distance indication receiver 645 may be configured as or otherwise support a means for receiving, from the network node, an indication of the distance that is based on the signals transmitted according to the configuration.

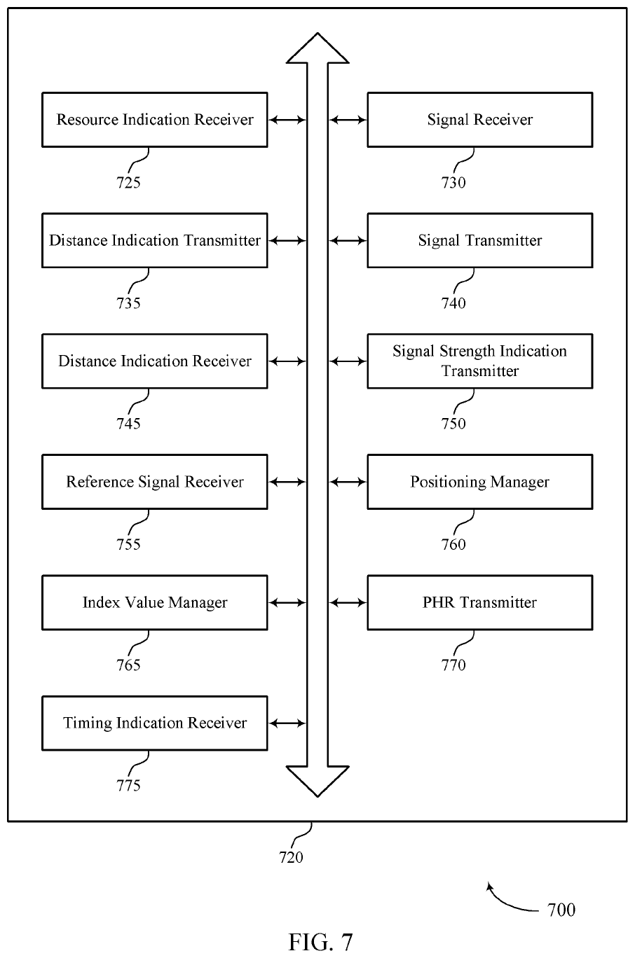

FIG. 7 shows a block diagram 700 of a communications manager 720 that supports signaling aspects of distance estimation for LOS MIMO communications in accordance with aspects of the present disclosure. The communications manager 720 may be an example of aspects of a communications manager 520, a communications manager 620, or both, as described herein. The communications manager 720, or various components thereof, may be an example of means for performing various aspects of signaling aspects of distance estimation for LOS MIMO communications as described herein. For example, the communications manager 720 may include a resource indication receiver 725, a signal receiver 730, a distance indication transmitter 735, a signal transmitter 740, a distance indication receiver 745, a signal strength indication transmitter 750, a reference signal receiver 755, a positioning manager 760, an index value manager 765, an PHR transmitter 770, a timing indication receiver 775, or any combination thereof. Each of these components may communicate, directly or indirectly, with one another (e.g., via one or more buses).

The resource indication receiver 725 may be configured as or otherwise support a means for receiving an indication of resources of a configuration for the wireless device to use to determine a distance between a first antenna array of the wireless device that includes a first set of multiple antenna elements and a second antenna array of a network node that includes a second set of multiple antenna elements. The signal receiver 730 may be configured as or otherwise support a means for receiving signals according to the indicated resources of the configuration. The distance indication transmitter 735 may be configured as or otherwise support a means for transmitting, to the network node, an indication of the distance that is based on the signals received according to the configuration.

In some examples, to support transmitting the indication of the distance, the signal strength indication transmitter 750 may be configured as or otherwise support a means for transmitting, to the network node, an indication of a signal strength value for the received signals that is determined by the wireless device.

In some examples, to support transmitting the indication of the distance, the distance indication transmitter 735 may be configured as or otherwise support a means for transmitting, to the network node, an indication of a distance value that is determined by the wireless device based at least in part a signal strength for the received signals.

In some examples, to support receiving the signals according to the indicated resources, the reference signal receiver 755 may be configured as or otherwise support a means for receiving channel state information reference signals, the indication of the distance determined by the wireless device based on the received channel state information reference signals.

In some examples, to support receiving the signals according to the indicated resources, the reference signal receiver 755 may be configured as or otherwise support a means for receiving second reference signals for determining the distance that are different from a channel state information reference signal, the indication of the distance determined by the wireless device based on the received second reference signals.

In some examples, the received signals include positioning signals received from one or more satellites of a global navigation system and, to support transmitting the indication of the distance, the positioning manager 760 may be configured as or otherwise support a means for transmitting positioning information for the wireless device that is based on the received positioning signals.

In some examples, the received signals include positioning reference signals received from one or more base stations and, to support transmitting the indication of the distance, the positioning manager 760 may be configured as or otherwise support a means for transmitting positioning information for the wireless device that is based on the received positioning reference signals.

In some examples, to support receiving the indication of the resources of the configuration, the timing indication receiver 775 may be configured as or otherwise support a means for receiving an indication of a period, where the indication of the distance is transmitted according to the period.

In some examples, to support receiving the indication of the resources of the configuration, the timing indication receiver 775 may be configured as or otherwise support a means for receiving an indication of at least one of a timer value or a threshold value for a difference between distances between the first antenna array and the second antenna array, where the wireless device is to transmit the indication of the distance to the network node according to the indication of the at least one of the timer value or the threshold value.

In some examples, the index value manager 765 may be configured as or otherwise support a means for receiving a set of index values and a set of distance values, each index value of the set of index values corresponding to one of the set of distance values. In some examples, the index value manager 765 may be configured as or otherwise support a means for selecting, from the set of index values based on the signals received according to the configuration, an index value corresponding to the distance, where the selected index value is the indication of the distance.

In some examples, the selected index value is transmitted as at least a portion of a channel state information report, an uplink LOS MAC CE, a second MAC CE different from the uplink LOS MAC CE, a measurement report, or any combination thereof. In some examples, the wireless device includes a UE or a relay node.

Additionally or alternatively, the communications manager 720 may support wireless communication at a wireless device in accordance with examples as disclosed herein. In some examples, the resource indication receiver 725 may be configured as or otherwise support a means for receiving, from a network node, an indication of resources of a configuration for the wireless device to use to transmit signals to the network node, the signals associated with the network node determining a distance between a first antenna array of the wireless device that includes a first set of multiple antenna elements and a second antenna array of the network node that includes a second set of multiple antenna elements. The signal transmitter 740 may be configured as or otherwise support a means for transmitting signals according to the indicated resources of the configuration. The distance indication receiver 745 may be configured as or otherwise support a means for receiving, from the network node, an indication of the distance that is based on the signals transmitted according to the configuration.

In some examples, to support transmitting the signals according to the indicated resources of the configuration, the PHR transmitter 770 may be configured as or otherwise support a means for transmitting a power headroom report that includes an indication of a pathloss associated with communications between the wireless device and the network node.

In some examples, to support receiving the indication of the resources of the configuration, the resource indication receiver 725 may be configured as or otherwise support a means for receiving the resources associated with an uplink reference signal for distance estimation, where transmitting the signals according to the indicated resources of the configuration includes transmitting the uplink reference signal on the indicated resources.

In some examples, the uplink reference signal includes a sounding reference signal, or a reference signal for the distance estimation that is different from the sounding reference signal, or any combination thereof.

In some examples, the positioning manager 760 may be configured as or otherwise support a means for receiving positioning signals from one or more satellites of a global navigation system, where transmitting the signals according to the indicated resources of the configuration includes transmitting an indication of positioning information for the wireless device that is determined based on the received positioning signals.

In some examples, to support receiving the indication of the distance, the distance indication receiver 745 may be configured as or otherwise support a means for receiving a MAC CE that includes the indication of the distance, a DCI message that includes the indication of the distance, or any combination thereof.

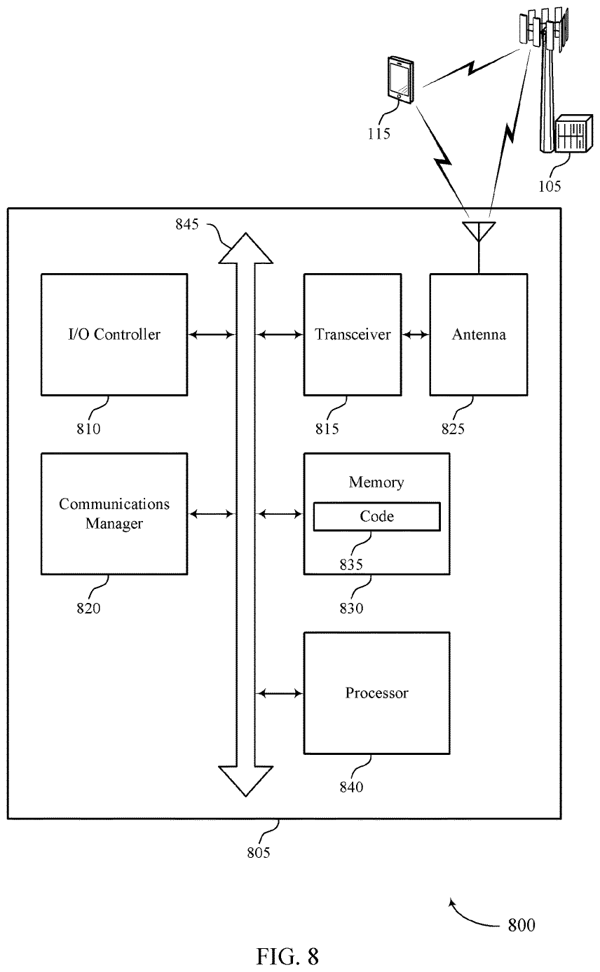

FIG. 8 shows a diagram of a system 800 including a device 805 that supports signaling aspects of distance estimation for LOS MIMO communications in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting signaling aspects of distance estimation for LOS MIMO communications). For example, the device 805 or a component of the device 805 may include a processor 840 and memory 830 coupled to the processor 840, the processor 840 and memory 830 configured to perform various functions described herein.

For example, the communications manager 820 may be configured as or otherwise support a means for receiving an indication of resources of a configuration for the wireless device to use to determine a distance between a first antenna array of the wireless device that includes a first set of multiple antenna elements and a second antenna array of a network node that includes a second set of multiple antenna elements. The communications manager 820 may be configured as or otherwise support a means for receiving signals according to the indicated resources of the configuration. The communications manager 820 may be configured as or otherwise support a means for transmitting, to the network node, an indication of the distance that is based on the signals received according to the configuration.

Additionally or alternatively, the communications manager 820 may support wireless communication at a wireless device in accordance with examples as disclosed herein. For example, the communications manager 820 may be configured as or otherwise support a means for receiving, from a network node, an indication of resources of a configuration for the wireless device to use to transmit signals to the network node, the signals associated with the network node determining a distance between a first antenna array of the wireless device that includes a first set of multiple antenna elements and a second antenna array of the network node that includes a second set of multiple antenna elements. The communications manager 820 may be configured as or otherwise support a means for transmitting signals according to the indicated resources of the configuration. The communications manager 820 may be configured as or otherwise support a means for receiving, from the network node, an indication of the distance that is based on the signals transmitted according to the configuration.

By including or configuring the communications manager 820 in accordance with examples as described herein, the device 805 may support techniques for communicating distance information for channel estimation procedures, resulting in improved communication reliability, improved user experience related to reduced processing, more efficient utilization of communication resources, improved coordination between devices, improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of signaling aspects of distance estimation for LOS MIMO communications as described herein, or the processor 840 and the memory 830 may be otherwise configured to perform or support such operations.

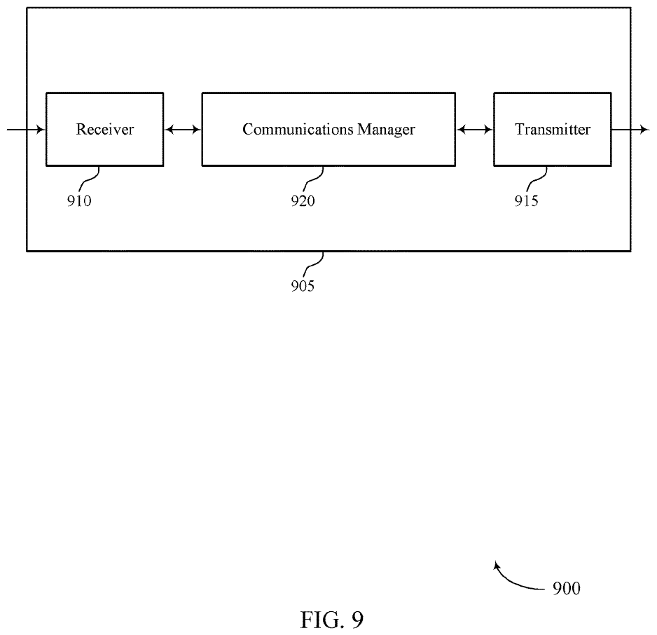

FIG. 9 shows a block diagram 900 of a device 905 that supports signaling aspects of distance estimation for LOS MIMO communications in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to signaling aspects of distance estimation for LOS MIMO communications). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to signaling aspects of distance estimation for LOS MIMO communications). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of signaling aspects of distance estimation for LOS MIMO communications as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communication at a network node in accordance with examples as disclosed herein. For example, the communications manager 920 may be configured as or otherwise support a means for transmitting, to a wireless device, an indication of resources of a configuration for the wireless device to use to determine a distance between a first antenna array of the wireless device that includes a first set of multiple antenna elements and a second antenna array of the network node that includes a second set of multiple antenna elements. The communications manager 920 may be configured as or otherwise support a means for transmitting signals according to the indicated resources of the configuration. The communications manager 920 may be configured as or otherwise support a means for receiving, from the wireless device, an indication of the distance that is based on the signals transmitted according to the configuration.

Additionally or alternatively, the communications manager 920 may support wireless communication at a network node in accordance with examples as disclosed herein. For example, the communications manager 920 may be configured as or otherwise support a means for transmitting, to a wireless device, an indication of resources of a configuration for the wireless device to use to transmit signals to the network node; the signals for determining a distance between a first antenna array of the wireless device that includes a first set of multiple antenna elements and a second antenna array of the network node that includes a second set of multiple antenna elements. The communications manager 920 may be configured as or otherwise support a means for receiving signals from the wireless device according to the indicated resources of the configuration. The communications manager 920 may be configured as or otherwise support a means for transmitting, to the wireless device, an indication of the distance determined by the network node based on the signals received from the wireless device according to the configuration.

By including or configuring the communications manager 920 in accordance with examples as described herein, the device 905 (e.g., a processor controlling or otherwise coupled to the receiver 910, the transmitter 915, the communications manager 920, or a combination thereof) may support techniques for communicating distance information for channel estimation procedures, resulting in reduced processing, reduced power consumption, and more efficient utilization of communication resources.

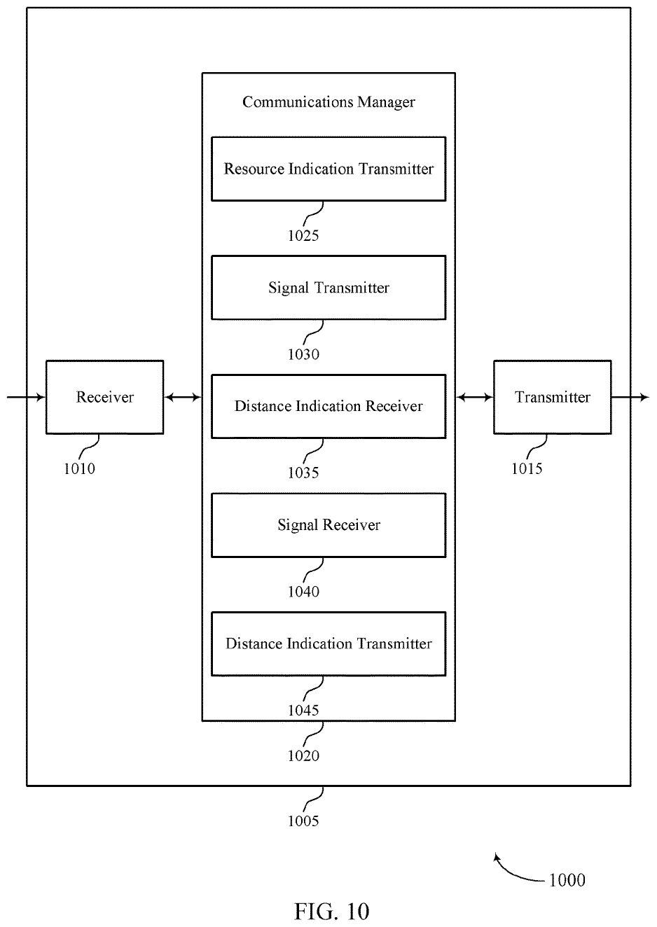

FIG. 10 shows a block diagram 1000 of a device 1005 that supports signaling aspects of distance estimation for LOS MIMO communications in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to signaling aspects of distance estimation for LOS MIMO communications). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to signaling aspects of distance estimation for LOS MIMO communications). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of signaling aspects of distance estimation for LOS MIMO communications as described herein. For example, the communications manager 1020 may include a resource indication transmitter 1025, a signal transmitter 1030, a distance indication receiver 1035, a signal receiver 1040, a distance indication transmitter 1045, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communication at a network node in accordance with examples as disclosed herein. The resource indication transmitter 1025 may be configured as or otherwise support a means for transmitting, to a wireless device, an indication of resources of a configuration for the wireless device to use to determine a distance between a first antenna array of the wireless device that includes a first set of multiple antenna elements and a second antenna array of the network node that includes a second set of multiple antenna elements. The signal transmitter 1030 may be configured as or otherwise support a means for transmitting signals according to the indicated resources of the configuration. The distance indication receiver 1035 may be configured as or otherwise support a means for receiving, from the wireless device, an indication of the distance that is based on the signals transmitted according to the configuration.

Additionally or alternatively, the communications manager 1020 may support wireless communication at a network node in accordance with examples as disclosed herein. The resource indication transmitter 1025 may be configured as or otherwise support a means for transmitting, to a wireless device, an indication of resources of a configuration for the wireless device to use to transmit signals to the network node; the signals for determining a distance between a first antenna array of the wireless device that includes a first set of multiple antenna elements and a second antenna array of the network node that includes a second set of multiple antenna elements. The signal receiver 1040 may be configured as or otherwise support a means for receiving signals from the wireless device according to the indicated resources of the configuration. The distance indication transmitter 1045 may be configured as or otherwise support a means for transmitting, to the wireless device, an indication of the distance determined by the network node based on the signals received from the wireless device according to the configuration.

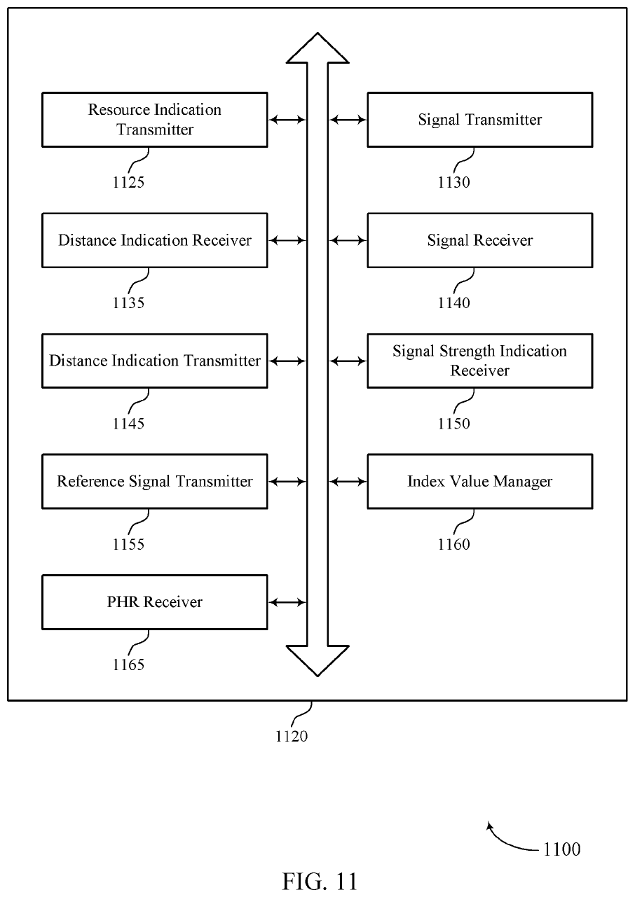

FIG. 11 shows a block diagram 1100 of a communications manager 1120 that supports signaling aspects of distance estimation for LOS MIMO communications in accordance with aspects of the present disclosure. The communications manager 1120 may be an example of aspects of a communications manager 920, a communications manager 1020, or both, as described herein. The communications manager 1120, or various components thereof, may be an example of means for performing various aspects of signaling aspects of distance estimation for LOS MIMO communications as described herein. For example, the communications manager 1120 may include a resource indication transmitter 1125, a signal transmitter 1130, a distance indication receiver 1135, a signal receiver 1140, a distance indication transmitter 1145, a signal strength indication receiver 1150, a reference signal transmitter 1155, an index value manager 1160, an PHR receiver 1165, or any combination thereof. Each of these components may communicate, directly or indirectly, with one another (e.g., via one or more buses).

The communications manager 1120 may support wireless communication at a network node in accordance with examples as disclosed herein. The resource indication transmitter 1125 may be configured as or otherwise support a means for transmitting, to a wireless device, an indication of resources of a configuration for the wireless device to use to determine a distance between a first antenna array of the wireless device that includes a first set of multiple antenna elements and a second antenna array of the network node that includes a second set of multiple antenna elements. The signal transmitter 1130 may be configured as or otherwise support a means for transmitting signals according to the indicated resources of the configuration. The distance indication receiver 1135 may be configured as or otherwise support a means for receiving, from the wireless device, an indication of the distance that is based on the signals transmitted according to the configuration.

In some examples, to support receiving the indication of the distance, the signal strength indication receiver 1150 may be configured as or otherwise support a means for receiving, from the wireless device, an indication of a signal strength value for the transmitted signals.

In some examples, to support receiving the indication of the distance, the distance indication receiver 1135 may be configured as or otherwise support a means for receiving, from the wireless device, an indication of a distance value that is determined by the wireless device.

In some examples, to support transmitting the signals according to the indicated resources, the reference signal transmitter 1155 may be configured as or otherwise support a means for transmitting channel state information reference signals, the indication of the distance device based on the transmitted channel state information reference signals.

In some examples, to support transmitting the signals according to the indicated resources, the reference signal transmitter 1155 may be configured as or otherwise support a means for transmitting second reference signals for determining the distance that are different from a channel state information reference signal, the indication of the distance based on the transmitted second reference signals.

In some examples, to support transmitting the indication of the resources of the configuration, the resource indication transmitter 1125 may be configured as or otherwise support a means for transmitting the indication of resources for the wireless device to use to receive positioning signals from one or more satellites of a global navigation system, resources for the wireless device to use to receive positioning reference signals from one or more base stations, or any combination thereof.

In some examples, the index value manager 1160 may be configured as or otherwise support a means for transmitting a set of index values and a set of distance values, each index value of the set of index values corresponding to one of the set of distance values, where the indication of the distance received from the wireless device includes an index value selected from the set of index values.

Additionally or alternatively, the communications manager 1120 may support wireless communication at a network node in accordance with examples as disclosed herein. In some examples, the resource indication transmitter 1125 may be configured as or otherwise support a means for transmitting, to a wireless device, an indication of resources of a configuration for the wireless device to use to transmit signals to the network node; the signals for determining a distance between a first antenna array of the wireless device that includes a first set of multiple antenna elements and a second antenna array of the network node that includes a second set of multiple antenna elements. The signal receiver 1140 may be configured as or otherwise support a means for receiving signals from the wireless device according to the indicated resources of the configuration. The distance indication transmitter 1145 may be configured as or otherwise support a means for transmitting, to the wireless device, an indication of the distance determined by the network node based on the signals received from the wireless device according to the configuration.

In some examples, to support receiving the signals according to the indicated resources of the configuration, the PHR receiver 1165 may be configured as or otherwise support a means for receiving a power headroom report that includes an indication of a pathloss associated with communications between the wireless device and the network node.

In some examples, to support transmitting the indication of the resources of the configuration, the resource indication transmitter 1125 may be configured as or otherwise support a means for transmitting the resources associated with an uplink reference signal for distance estimation for the wireless device to use to transit to the network node, where the received signals include the uplink reference signal.

In some examples, the uplink reference signal includes a sounding reference signal, or a reference signal for distance estimation that is different from the sounding reference signal, or any combination thereof.

In some examples, the signal receiver 1140 may be configured as or otherwise support a means for receiving positioning signals from one or more satellites of a global navigation system, where transmitting signals according to the indicated resources of the configuration includes transmitting an indication of positioning information for the wireless device that is determined based on the received positioning signals.

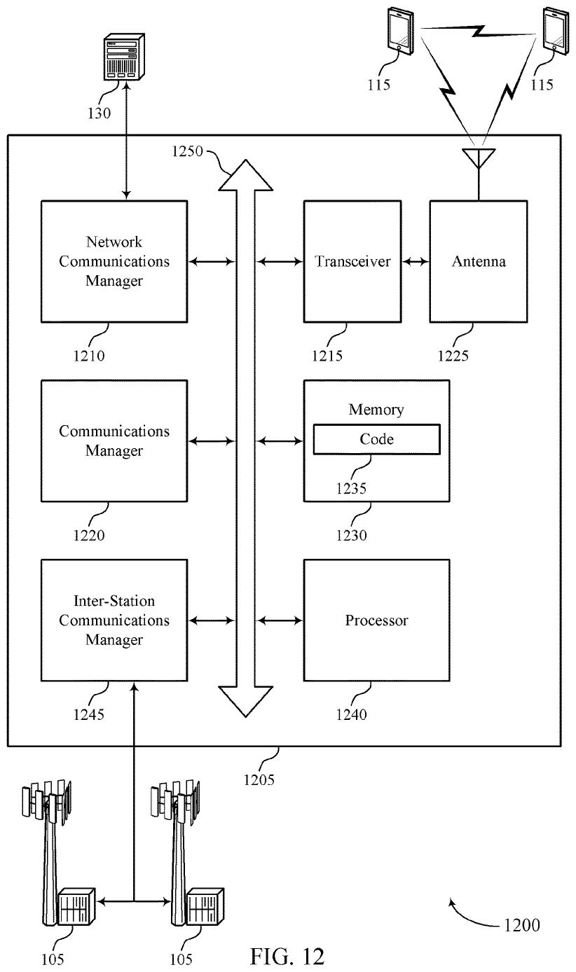

FIG. 12 shows a diagram of a system 1200 including a device 1205 that supports signaling aspects of distance estimation for LOS MIMO communications in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting signaling aspects of distance estimation for LOS MIMO communications). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communication at a network node in accordance with examples as disclosed herein. For example, the communications manager 1220 may be configured as or otherwise support a means for transmitting, to a wireless device, an indication of resources of a configuration for the wireless device to use to determine a distance between a first antenna array of the wireless device that includes a first set of multiple antenna elements and a second antenna array of the network node that includes a second set of multiple antenna elements. The communications manager 1220 may be configured as or otherwise support a means for transmitting signals according to the indicated resources of the configuration. The communications manager 1220 may be configured as or otherwise support a means for receiving, from the wireless device, an indication of the distance that is based on the signals transmitted according to the configuration.

Additionally or alternatively, the communications manager 1220 may support wireless communication at a network node in accordance with examples as disclosed herein. For example, the communications manager 1220 may be configured as or otherwise support a means for transmitting, to a wireless device, an indication of resources of a configuration for the wireless device to use to transmit signals to the network node; the signals for determining a distance between a first antenna array of the wireless device that includes a first set of multiple antenna elements and a second antenna array of the network node that includes a second set of multiple antenna elements. The communications manager 1220 may be configured as or otherwise support a means for receiving signals from the wireless device according to the indicated resources of the configuration. The communications manager 1220 may be configured as or otherwise support a means for transmitting, to the wireless device, an indication of the distance determined by the network node based on the signals received from the wireless device according to the configuration.

By including or configuring the communications manager 1220 in accordance with examples as described herein, the device 1205 may support techniques for communicating distance information for channel estimation procedures, resulting in improved communication reliability, improved user experience related to reduced processing, reduced power consumption, more efficient utilization of communication resources, improved coordination between devices, and improved utilization of processing capability.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of signaling aspects of distance estimation for LOS MIMO communications as described herein, or the processor 1240 and the memory 1230 may be otherwise configured to perform or support such operations.

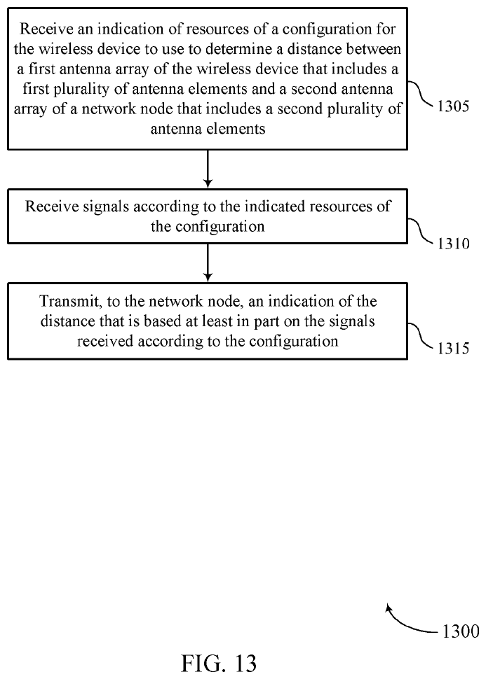

FIG. 13 shows a flowchart illustrating a method 1300 that supports signaling aspects of distance estimation for LOS MIMO communications in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving an indication of resources of a configuration for the wireless device to use to determine a distance between a first antenna array of the wireless device that includes a first set of multiple antenna elements and a second antenna array of a network node that includes a second set of multiple antenna elements. The operations of 1305 may be performed in accordance with examples as disclosed herein. In some examples, aspects of the operations of 1305 may be performed by a resource indication receiver 725 as described with reference to FIG. 7.

At 1310, the method may include receiving signals according to the indicated resources of the configuration. The operations of 1310 may be performed in accordance with examples as disclosed herein. In some examples, aspects of the operations of 1310 may be performed by a signal receiver 730 as described with reference to FIG. 7.

At 1315, the method may include transmitting, to the network node, an indication of the distance that is based on the signals received according to the configuration. The operations of 1315 may be performed in accordance with examples as disclosed herein. In some examples, aspects of the operations of 1315 may be performed by a distance indication transmitter 735 as described with reference to FIG. 7.

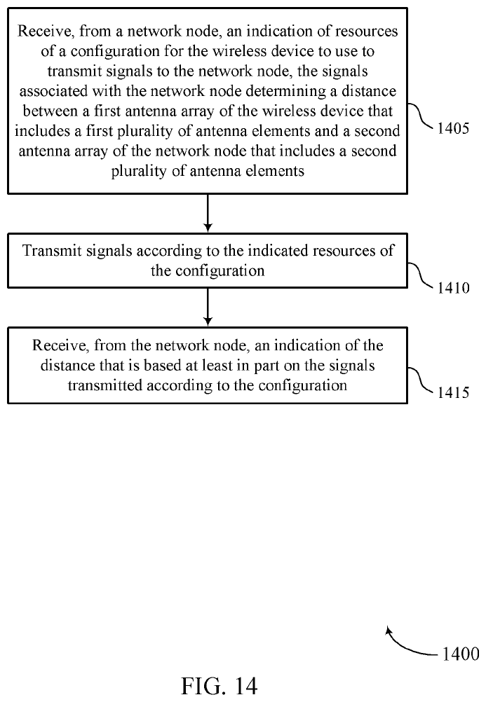

FIG. 14 shows a flowchart illustrating a method 1400 that supports signaling aspects of distance estimation for LOS MIMO communications in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, from a network node, an indication of resources of a configuration for the wireless device to use to transmit signals to the network node, the signals associated with the network node determining a distance between a first antenna array of the wireless device that includes a first set of multiple antenna elements and a second antenna array of the network node that includes a second set of multiple antenna elements. The operations of 1405 may be performed in accordance with examples as disclosed herein. In some examples, aspects of the operations of 1405 may be performed by a resource indication receiver 725 as described with reference to FIG. 7.

At 1410, the method may include transmitting signals according to the indicated resources of the configuration. The operations of 1410 may be performed in accordance with examples as disclosed herein. In some examples, aspects of the operations of 1410 may be performed by a signal transmitter 740 as described with reference to FIG. 7.

At 1415, the method may include receiving, from the network node, an indication of the distance that is based on the signals transmitted according to the configuration. The operations of 1415 may be performed in accordance with examples as disclosed herein. In some examples, aspects of the operations of 1415 may be performed by a distance indication receiver 745 as described with reference to FIG. 7.

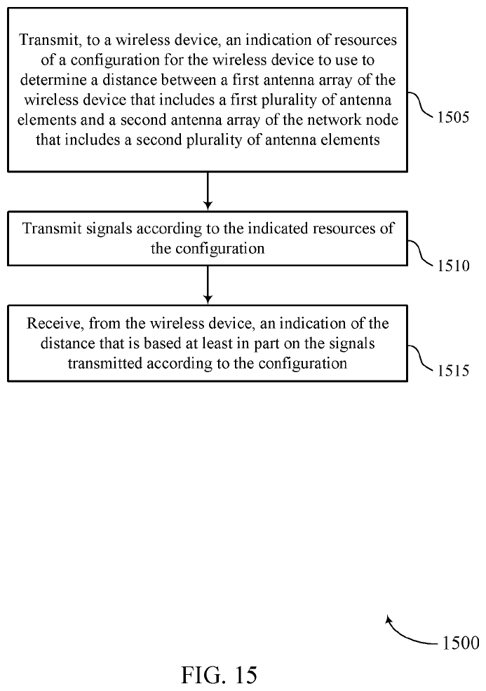

FIG. 15 shows a flowchart illustrating a method 1500 that supports signaling aspects of distance estimation for LOS MIMO communications in accordance with aspects of the present disclosure. The operations of the method 1500 may be implemented by a base station or its components as described herein. For example, the operations of the method 1500 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1505, the method may include transmitting, to a wireless device, an indication of resources of a configuration for the wireless device to use to determine a distance between a first antenna array of the wireless device that includes a first set of multiple antenna elements and a second antenna array of the network node that includes a second set of multiple antenna elements. The operations of 1505 may be performed in accordance with examples as disclosed herein. In some examples, aspects of the operations of 1505 may be performed by a resource indication transmitter 1125 as described with reference to FIG. 11.

At 1510, the method may include transmitting signals according to the indicated resources of the configuration. The operations of 1510 may be performed in accordance with examples as disclosed herein. In some examples, aspects of the operations of 1510 may be performed by a signal transmitter 1130 as described with reference to FIG. 11.

At 1515, the method may include receiving, from the wireless device, an indication of the distance that is based on the signals transmitted according to the configuration. The operations of 1515 may be performed in accordance with examples as disclosed herein. In some examples, aspects of the operations of 1515 may be performed by a distance indication receiver 1135 as described with reference to FIG. 11.

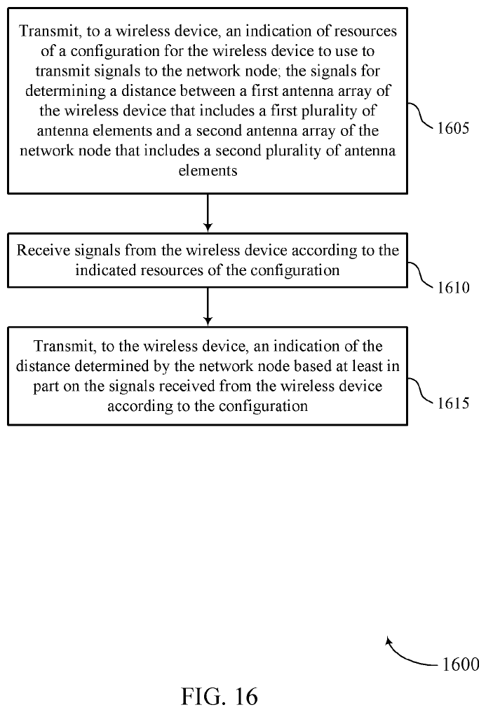

FIG. 16 shows a flowchart illustrating a method 1600 that supports signaling aspects of distance estimation for LOS MIMO communications in accordance with aspects of the present disclosure. The operations of the method 1600 may be implemented by a base station or its components as described herein. For example, the operations of the method 1600 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1605, the method may include transmitting, to a wireless device, an indication of resources of a configuration for the wireless device to use to transmit signals to the network node; the signals for determining a distance between a first antenna array of the wireless device that includes a first set of multiple antenna elements and a second antenna array of the network node that includes a second set of multiple antenna elements. The operations of 1605 may be performed in accordance with examples as disclosed herein. In some examples, aspects of the operations of 1605 may be performed by a resource indication transmitter 1125 as described with reference to FIG. 11.

At 1610, the method may include receiving signals from the wireless device according to the indicated resources of the configuration. The operations of 1610 may be performed in accordance with examples as disclosed herein. In some examples, aspects of the operations of 1610 may be performed by a signal receiver 1140 as described with reference to FIG. 11.

At 1615, the method may include transmitting, to the wireless device, an indication of the distance determined by the network node based on the signals received from the wireless device according to the configuration. The operations of 1615 may be performed in accordance with examples as disclosed herein. In some examples, aspects of the operations of 1615 may be performed by a distance indication transmitter 1145 as described with reference to FIG. 11.

The following provides an overview of aspects of the present disclosure:

Aspect 1: A method for wireless communication at a wireless device, comprising: receiving an indication of resources of a configuration for the wireless device to use to determine a distance between a first antenna array of the wireless device that includes a first plurality of antenna elements and a second antenna array of a network node that includes a second plurality of antenna elements; receiving signals according to the indicated resources of the configuration; and transmitting, to the network node, an indication of the distance that is based at least in part on the signals received according to the configuration.

Aspect 2: The method of aspect 1, wherein transmitting the indication of the distance comprises: transmitting, to the network node, an indication of a signal strength value for the received signals that is determined by the wireless device.

Aspect 3: The method of any of aspects 1 through 2, wherein transmitting the indication of the distance comprises: transmitting, to the network node, an indication of a distance value that is determined by the wireless device based at least in part a signal strength for the received signals.

Aspect 4: The method of any of aspects 1 through 3, wherein receiving the signals according to the indicated resources comprises: receiving channel state information reference signals, the indication of the distance determined by the wireless device based at least in part on the received channel state information reference signals.

Aspect 5: The method of any of aspects 1 through 4, wherein receiving the signals according to the indicated resources comprises: receiving second reference signals for determining the distance that are different from a channel state information reference signal, the indication of the distance determined by the wireless device based at least in part on the received second reference signals.

Aspect 6: The method of any of aspects 1 through 5, wherein the received signals comprise positioning signals received from one or more satellites of a global navigation system, and transmitting the indication of the distance comprises: transmitting positioning information for the wireless device that is based at least in part on the received positioning signals.

Aspect 7: The method of any of aspects 1 through 6, wherein the received signals comprise positioning reference signals received from one or more base stations, and transmitting the indication of the distance comprises: transmitting positioning information for the wireless device that is based at least in part on the received positioning reference signals.

Aspect 8: The method of aspect 7, wherein receiving the indication of the resources of the configuration comprises: receiving an indication of a period, wherein the indication of the distance is transmitted according to the period.

Aspect 9: The method of any of aspects 7 through 8, wherein receiving the indication of the resources of the configuration comprises: receiving an indication of at least one of a timer value or a threshold value for a difference between distances between the first antenna array and the second antenna array, wherein the wireless device is to transmit the indication of the distance to the network node according to the indication of the at least one of the timer value or the threshold value.

Aspect 10: The method of any of aspects 1 through 9, further comprising: receiving a set of index values and a set of distance values, each index value of the set of index values corresponding to one of the set of distance values; and selecting, from the set of index values based at least in part on the signals received according to the configuration, an index value corresponding to the distance, wherein the selected index value is the indication of the distance.

Aspect 11: The method of aspect 10, wherein the selected index value is transmitted as at least a portion of a channel state information report, an uplink line of sight MAC control element (CE), a second MAC CE different from the uplink line of sight MAC CE, a measurement report, or any combination thereof.

Aspect 12: The method of any of aspects 1 through 11, wherein the wireless device comprises a UE or a relay node.

Aspect 13: A method for wireless communication at a wireless device, comprising: receiving, from a network node, an indication of resources of a configuration for the wireless device to use to transmit signals to the network node, the signals associated with the network node determining a distance between a first antenna array of the wireless device that includes a first plurality of antenna elements and a second antenna array of the network node that includes a second plurality of antenna elements; transmitting signals according to the indicated resources of the configuration; and receiving, from the network node, an indication of the distance that is based at least in part on the signals transmitted according to the configuration.

Aspect 14: The method of aspect 13, wherein transmitting the signals according to the indicated resources of the configuration comprises: transmitting a power headroom report that includes an indication of a pathloss associated with communications between the wireless device and the network node.

Aspect 15: The method of any of aspects 13 through 14, wherein receiving the indication of the resources of the configuration comprises: receiving the resources associated with an uplink reference signal for distance estimation, wherein transmitting the signals according to the indicated resources of the configuration comprises transmitting the uplink reference signal on the indicated resources.

Aspect 16: The method of aspect 15, wherein the uplink reference signal comprises a sounding reference signal, or a reference signal for the distance estimation that is different from the sounding reference signal, or any combination thereof.

Aspect 17: The method of any of aspects 13 through 16, further comprising: receiving positioning signals from one or more satellites of a global navigation system, wherein transmitting the signals according to the indicated resources of the configuration comprises transmitting an indication of positioning information for the wireless device that is determined based at least in part on the received positioning signals.

Aspect 18: The method of any of aspects 13 through 17, wherein receiving the indication of the distance comprises: receiving a MAC control element (CE) that includes the indication of the distance, a downlink control information message that includes the indication of the distance, or any combination thereof.

Aspect 19: A method for wireless communication at a network node, comprising: transmitting, to a wireless device, an indication of resources of a configuration for the wireless device to use to determine a distance between a first antenna array of the wireless device that includes a first plurality of antenna elements and a second antenna array of the network node that includes a second plurality of antenna elements; transmitting signals according to the indicated resources of the configuration; and receiving, from the wireless device, an indication of the distance that is based at least in part on the signals transmitted according to the configuration.

Aspect 20: The method of aspect 19, wherein receiving the indication of the distance comprises: receiving, from the wireless device, an indication of a signal strength value for the transmitted signals.

Aspect 21: The method of any of aspects 19 through 20, wherein receiving the indication of the distance comprises: receiving, from the wireless device, an indication of a distance value that is determined by the wireless device.

Aspect 22: The method of any of aspects 19 through 21, wherein transmitting the signals according to the indicated resources comprises: transmitting channel state information reference signals, the indication of the distance device based at least in part on the transmitted channel state information reference signals.

Aspect 23: The method of any of aspects 19 through 22, wherein transmitting the signals according to the indicated resources comprises: transmitting second reference signals for determining the distance that are different from a channel state information reference signal, the indication of the distance based at least in part on the transmitted second reference signals.

Aspect 24: The method of any of aspects 19 through 23, wherein transmitting the indication of the resources of the configuration comprises: transmitting the indication of resources for the wireless device to use to receive positioning signals from one or more satellites of a global navigation system, resources for the wireless device to use to receive positioning reference signals from one or more base stations, or any combination thereof.

Aspect 25: The method of any of aspects 19 through 24, further comprising: transmitting a set of index values and a set of distance values, each index value of the set of index values corresponding to one of the set of distance values, wherein the indication of the distance received from the wireless device comprises an index value selected from the set of index values.

Aspect 26: A method for wireless communication at a network node, comprising: transmitting, to a wireless device, an indication of resources of a configuration for the wireless device to use to transmit signals to the network node; the signals for determining a distance between a first antenna array of the wireless device that includes a first plurality of antenna elements and a second antenna array of the network node that includes a second plurality of antenna elements; receiving signals from the wireless device according to the indicated resources of the configuration; and transmitting, to the wireless device, an indication of the distance determined by the network node based at least in part on the signals received from the wireless device according to the configuration.

Aspect 27: The method of aspect 26, wherein receiving the signals according to the indicated resources of the configuration comprises: receiving a power headroom report that includes an indication of a pathloss associated with communications between the wireless device and the network node.

Aspect 28: The method of any of aspects 26 through 27, wherein transmitting the indication of the resources of the configuration comprises: transmitting the resources associated with an uplink reference signal for distance estimation for the wireless device to use to transit to the network node, wherein the received signals comprise the uplink reference signal.

Aspect 29: The method of aspect 28, wherein the uplink reference signal comprises a sounding reference signal, or a reference signal for distance estimation that is different from the sounding reference signal, or any combination thereof.

Aspect 30: The method of any of aspects 26 through 29, further comprising: receiving positioning signals from one or more satellites of a global navigation system, wherein transmitting signals according to the indicated resources of the configuration comprises transmitting an indication of positioning information for the wireless device that is determined based at least in part on the received positioning signals.

Aspect 31: An apparatus comprising a processor; memory coupled with the processor; and instructions stored in the memory and executable by the processor to cause the apparatus to perform a method of any of aspects 1 through 12.

Aspect 32: An apparatus comprising at least one means for performing a method of any of aspects 1 through 12.

Aspect 33: A non-transitory computer-readable medium storing code the code comprising instructions executable by a processor to perform a method of any of aspects 1 through 12.

Aspect 34: An apparatus for wireless communication at a wireless device, comprising a processor; memory coupled with the processor; and instructions stored in the memory and executable by the processor to cause the apparatus to perform a method of any of aspects 13 through 18.

Aspect 35: An apparatus for wireless communication at a wireless device, comprising at least one means for performing a method of any of aspects 13 through 18.

Aspect 36: A non-transitory computer-readable medium storing code for wireless communication at a wireless device, the code comprising instructions executable by a processor to perform a method of any of aspects 13 through 18.

Aspect 37: An apparatus for wireless communication at a network node, comprising a processor; memory coupled with the processor; and instructions stored in the memory and executable by the processor to cause the apparatus to perform a method of any of aspects 19 through 25.

Aspect 38: An apparatus for wireless communication at a network node, comprising at least one means for performing a method of any of aspects 19 through 25.

Aspect 39: A non-transitory computer-readable medium storing code for wireless communication at a network node, the code comprising instructions executable by a processor to perform a method of any of aspects 19 through 25.

Aspect 40: An apparatus for wireless communication at a network node, comprising a processor; memory coupled with the processor; and instructions stored in the memory and executable by the processor to cause the apparatus to perform a method of any of aspects 26 through 30.

Aspect 41: An apparatus for wireless communication at a network node, comprising at least one means for performing a method of any of aspects 26 through 30.

Aspect 42: A non-transitory computer-readable medium storing code for wireless communication at a network node, the code comprising instructions executable by a processor to perform a method of any of aspects 26 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a wireless device, comprising:
a processor;
memory coupled with the processor; and
instructions stored in the memory and executable by the processor to cause the apparatus to:
receive an indication of resources of a configuration for the wireless device to use to determine a distance between a first antenna array of the wireless device that includes a first plurality of antenna elements and a second antenna array of a network node that includes a second plurality of antenna elements;
receive signals according to the indicated resources of the configuration; and
transmit, to the network node, an indication of the distance that is based at least in part on the signals received according to the configuration.

2. The apparatus of claim 1, wherein the instructions to transmit the indication of the distance are executable by the processor to cause the apparatus to:
transmit, to the network node, an indication of a signal strength value for the received signals that is determined by the wireless device.

3. The apparatus of claim 1, wherein the instructions to transmit the indication of the distance are executable by the processor to cause the apparatus to:
transmit, to the network node, an indication of a distance value that is determined by the wireless device based at least in part a signal strength for the received signals.

4. The apparatus of claim 1, wherein the instructions to receive the signals according to the indicated resources are executable by the processor to cause the apparatus to:
receive channel state information reference signals, the indication of the distance determined by the wireless device based at least in part on the received channel state information reference signals.

5. The apparatus of claim 1, wherein the instructions to receive the signals according to the indicated resources are executable by the processor to cause the apparatus to:
receive second reference signals for determining the distance that are different from a channel state information reference signal, the indication of the distance determined by the wireless device based at least in part on the received second reference signals.

6. The apparatus of claim 1, wherein the received signals comprise positioning signals received from one or more satellites of a global navigation system, and the instructions to transmit the indication of the distance are executable by the processor to cause the apparatus to:
transmit positioning information for the wireless device that is based at least in part on the received positioning signals.

7. The apparatus of claim 1, wherein the received signals comprise positioning reference signals received from one or more base stations, and the instructions to transmit the indication of the distance are executable by the processor to cause the apparatus to:
transmit positioning information for the wireless device that is based at least in part on the received positioning reference signals.

8. The apparatus of claim 7, wherein the instructions to receive the indication of the resources of the configuration are executable by the processor to cause the apparatus to:
receive an indication of a period, wherein the indication of the distance is transmitted according to the period.

9. The apparatus of claim 7, wherein the instructions to receive the indication of the resources of the configuration are executable by the processor to cause the apparatus to:
receive an indication of at least one of a timer value or a threshold value for a difference between distances between the first antenna array and the second antenna array, wherein the wireless device is to transmit the indication of the distance to the network node according to the indication of the at least one of the timer value or the threshold value.

10. The apparatus of claim 1, wherein the instructions are further executable by the processor to cause the apparatus to:
receive a set of index values and a set of distance values, each index value of the set of index values corresponding to one of the set of distance values; and
select, from the set of index values based at least in part on the signals received according to the configuration, an index value corresponding to the distance, wherein the selected index value is the indication of the distance.

11. The apparatus of claim 10, wherein the selected index value is transmitted as at least a portion of a channel state information report, an uplink line of sight media access control (MAC) control element (CE), a second MAC CE different from the uplink line of sight MAC CE, a measurement report, or any combination thereof.

12. The apparatus of claim 1, wherein the wireless device comprises a user equipment (UE) or a relay node.

13. An apparatus for wireless communication at a wireless device, comprising:
a processor;
memory coupled with the processor; and
instructions stored in the memory and executable by the processor to cause the apparatus to:
receive, from a network node, an indication of resources of a configuration for the wireless device to use to transmit signals to the network node, the signals associated with the network node determining a distance between a first antenna array of the wireless device that includes a first plurality of antenna elements and a second antenna array of the network node that includes a second plurality of antenna elements;
transmit signals according to the indicated resources of the configuration; and
receive, from the network node, an indication of the distance that is based at least in part on the signals transmitted according to the configuration.

14. The apparatus of claim 13, wherein the instructions to transmit the signals according to the indicated resources of the configuration are executable by the processor to cause the apparatus to:
transmit a power headroom report that includes an indication of a pathloss associated with communications between the wireless device and the network node.

15. The apparatus of claim 13, wherein the instructions to receive the indication of the resources of the configuration are executable by the processor to cause the apparatus to:
receive the resources associated with an uplink reference signal for distance estimation, wherein transmitting the signals according to the indicated resources of the configuration comprises transmitting the uplink reference signal on the indicated resources.

16. The apparatus of claim 15, wherein the uplink reference signal comprises a sounding reference signal, or a reference signal for the distance estimation that is different from the sounding reference signal, or any combination thereof.

17. The apparatus of claim 13, wherein the instructions are further executable by the processor to cause the apparatus to:
receive positioning signals from one or more satellites of a global navigation system, wherein transmitting the signals according to the indicated resources of the configuration comprises transmitting an indication of positioning information for the wireless device that is determined based at least in part on the received positioning signals.

18. The apparatus of claim 13, wherein the instructions to receive the indication of the distance are executable by the processor to cause the apparatus to:
receive a media access control (MAC) control element (CE) that includes the indication of the distance, a downlink control information message that includes the indication of the distance, or any combination thereof.

19. An apparatus for wireless communication at a network node, comprising:
a processor;
memory coupled with the processor; and
instructions stored in the memory and executable by the processor to cause the apparatus to:
transmit, to a wireless device, an indication of resources of a configuration for the wireless device to use to determine a distance between a first antenna array of the wireless device that includes a first plurality of antenna elements and a second antenna array of the network node that includes a second plurality of antenna elements;
transmit signals according to the indicated resources of the configuration; and
receive, from the wireless device, an indication of the distance that is based at least in part on the signals transmitted according to the configuration.

20. The apparatus of claim 19, wherein the instructions to receive the indication of the distance are executable by the processor to cause the apparatus to:
receive, from the wireless device, an indication of a signal strength value for the transmitted signals.

21. The apparatus of claim 19, wherein the instructions to receive the indication of the distance are executable by the processor to cause the apparatus to:
receive, from the wireless device, an indication of a distance value that is determined by the wireless device.

22. The apparatus of claim 19, wherein the instructions to transmit the signals according to the indicated resources are executable by the processor to cause the apparatus to:
transmit channel state information reference signals, the indication of the distance based at least in part on the transmitted channel state information reference signals.

23. The apparatus of claim 19, wherein the instructions to transmit the signals according to the indicated resources are executable by the processor to cause the apparatus to:
transmit second reference signals for determining the distance that are different from a channel state information reference signal, the indication of the distance based at least in part on the transmitted second reference signals.

24. The apparatus of claim 19, wherein the instructions to transmit the indication of the resources of the configuration are executable by the processor to cause the apparatus to:
transmit the indication of resources for the wireless device to use to receive positioning signals from one or more satellites of a global navigation system, resources for the wireless device to use to receive positioning reference signals from one or more base stations, or any combination thereof.

25. The apparatus of claim 19, wherein the instructions are further executable by the processor to cause the apparatus to:
transmit a set of index values and a set of distance values, each index value of the set of index values corresponding to one of the set of distance values, wherein the indication of the distance received from the wireless device comprises an index value selected from the set of index values.

26. An apparatus for wireless communication at a network node, comprising:
a processor;
memory coupled with the processor; and
instructions stored in the memory and executable by the processor to cause the apparatus to:
transmit, to a wireless device, an indication of resources of a configuration for the wireless device to use to transmit signals to the network node; the signals for determining a distance between a first antenna array of the wireless device that includes a first plurality of antenna elements and a second antenna array of the network node that includes a second plurality of antenna elements;
receive signals from the wireless device according to the indicated resources of the configuration; and
transmit, to the wireless device, an indication of the distance determined by the network node based at least in part on the signals received from the wireless device according to the configuration.

27. The apparatus of claim 26, wherein the instructions to receive the signals according to the indicated resources of the configuration are executable by the processor to cause the apparatus to:
receive a power headroom report that includes an indication of a pathloss associated with communications between the wireless device and the network node.

28. The apparatus of claim 26, wherein the instructions to transmit the indication of the resources of the configuration are executable by the processor to cause the apparatus to:
transmit the resources associated with an uplink reference signal for distance estimation for the wireless device to use to transmit to the network node, wherein the received signals comprise the uplink reference signal.

29. The apparatus of claim 28, wherein the uplink reference signal comprises a sounding reference signal, or a reference signal for distance estimation that is different from the sounding reference signal, or any combination thereof.

30. The apparatus of claim 26, wherein the instructions are further executable by the processor to cause the apparatus to:
receive positioning signals from one or more satellites of a global navigation system, wherein transmitting signals according to the indicated resources of the configuration comprises transmitting an indication of positioning information for the wireless device that is determined based at least in part on the received positioning signals.
